(19) United States
(12) Patent Application Publication
(10) Pub. No.: US 2021/0392981 A1
(43) Pub. Date: Dec. 23, 2021

(54) ARC FLASH PROTECTIVE MATERIALS

(71) Applicant: W. L. Gore & Associates GmbH, Putzbrunn (DE)

(72) Inventors: Bernd Zischka, Putzbrunn (DE); John Ruediger, Putzbrunn (DE)

(21) Appl. No.: 17/274,072

(22) PCT Filed: Sep. 10, 2019
(86) PCT No.: PCT/IB2019/000993

§ 371 Date: Mar. 5, 2021

Related U.S. Application Data
(60) Provisional application No. 62/729,165, filed on Sep. 10, 2018.

(51) Int. Cl. A41D 31/08; B32B 5/02; B32B 7/14; B32B 27/12; B32B 27/20; B32B 27/30

(52) U.S. Cl. CPC A41D 31/085; A41D 2500/20; B32B 7/14; B32B 27/12; B32B 27/20; B32B 27/304; B32B 2307/308; B32B 2307/3065; B32B 2437/00; B32B 2250/03; B32B 2255/02; B32B 2255/20; B32B 2255/26; B32B 2307/718; B32B 2266/0235; B32B 2262/02; B32B 2307/7265; B32B 5/02

(57) ABSTRACT

Relatively lightweight laminate structures having an outer textile layer, a heat reactive material, a middle layer, a flame retardant adhesive material and an inner layer, wherein the flame retardant adhesive material is positioned in a pattern so as to form a plurality of pockets, each of the pockets defined by (a) the middle layer, (b) the inner layer, and (c) a portion of the flame retardant adhesive material. The laminate structures can provide protection from an exposure to an electrical arc.

### FIELD OF THE INVENTION

The present invention relates to protective textiles. More particularly, the present invention relates to lightweight textiles that provide protection against electric arc flashes and similar types of applied energy.

### BACKGROUND

In order to reduce injuries, protective clothing is desired for professionals working in hazardous environments where short duration exposure to electric arc flashes is possible, such as utility repair. Protective gear for workers exposed to these conditions should provide some enhanced protection to allow the wearer to get away from the hazard quickly and safely, rather than to repair the hazard.

Traditionally, arc resistant protective garments provide fire and heat protection. Such garments have been made with an outermost layer of an ensemble comprising non-combustible, non-melting fabric made of, for example, aramids, polybenzimidazole (PBI), poly p-phenylene-2,6-benzobisoxazole (PBO), modacrylic blends, polyamines, carbon, polyacrylonitrile (PAN), and blends and combinations thereof. These fibers may be inherently flame resistant but may have several limitations. Specifically, in order to achieve the desired level of protection, relatively heavy weight, bulky fabrics are required. Typically, these fabrics can have a basis weight in excess of 400 grams/meter². The fibers used to form these fabrics may be very expensive, difficult to dye and print, and may not have adequate abrasion resistance. Additionally, these fibers pick up more water and offer unsatisfactory tactile comfort as compared to nylon or polyester based fabrics. For optimum user performance in environments with occasional arc flash exposure, a lightweight, breathable, water resistant garment with enhanced burn protection is desired. The cost of waterproof, arc flash resistant, protective clothing has been an important consideration for the large number of hazardous exposure applications, thereby precluding the use of typical, inherently flame resistant textiles such as those used in firefighting community.

### SUMMARY

In an aspect, there is provided a laminate structure providing thermal insulation, the laminate structure comprising:

an outer textile layer having an outer surface and an inner surface,
a heat reactive material;
a middle layer having an outer surface and an inner surface, wherein the middle layer is positioned on the heat reactive material opposite the outer textile layer such that the heat reactive material is sandwiched between the inner surface of the outer textile layer and the outer surface of the middle layer, wherein the heat reactive material bonds the middle layer to the outer textile layer;
a flame retardant adhesive material; and
an inner layer having an outer surface and an inner surface, wherein the inner layer is positioned on the flame retardant adhesive material opposite the middle layer such that the flame retardant adhesive material is sandwiched between the inner surface of the middle layer and the outer surface of the inner layer, wherein the flame retardant adhesive material bonds the inner layer to the middle layer,
wherein the flame retardant adhesive material is positioned in a pattern so as to form a plurality of pockets, each of the pockets defined by (a) the middle layer, (b) the inner layer, and (c) a portion of the flame retardant adhesive material.

The outer textile layer may be a knit, woven or a nonwoven.

The outer textile layer may be meltable. The outer textile layer may have a lower melting point than the middle layer. The outer textile layer may have a lower melting point than the inner layer. As used herein, a “meltable” material is a material that is meltable when tested according to the Melting and Thermal Stability test described hereinafter.

The outer textile layer may be flammable or non-flammable. As used herein, a “flammable” material is a material that is flammable when tested according to the Vertical Flame Test for Textiles described hereinafter to determine whether it is flammable or non-flammable.

The outer textile layer may be a meltable non-flammable textile such as, for example, a phosphinate modified polyester (such as materials sold under the trade name TREVIRA® CS by Trevira GmbH of Hattersheim Germany and under the trade name AVORA® FR by Rose Brand of Secaucus, N.J., USA).

The outer textile layer may comprise relatively small quantities of flame retardant fibers, non-meltable fibers and/or antistatic fibers. If present, the flame retardant fibers, the non-meltable fibers and/or the antistatic fibers are present so that the outer textile is still a meltable textile when tested according to the Melting and Thermal Stability test described hereinafter.

The outer textile layer may comprise a quantity of meltable fibers in a range from 50% to 100% by weight of meltable fibers. The outer textile layer may comprise a quantity of meltable fibers in a range from 75 to 100% by weight. The outer textile layer may comprise a quantity of meltable fibers in a range from 90% to 100% by weight. The outer textile layer may comprise a quantity of meltable fibers in a range from 95% to 99% by weight. The remainder of the fibers may be antistatic fibers, meltable elastic fibers, non-meltable elastic fibers or a combination thereof. For example, when the outer textile layer comprises a quantity of meltable fibers in a range from 95 to 99% by weight, the antistatic and/or elastic fibres may be present in the range of from 1 to 5% by weight. All percentages by weight are based on the total weight of the outer textile layer.

Meltable textiles are not typically used in arc resistant laminates as the standards governing the testing of arc resistant garments requires that the fabric or laminate be flame resistant in order to even qualify for arc testing (ASTM 1959). It is surprising that a laminate structure comprising an outer textile layer that is meltable can be used to provide protection against arc flash incidents.

The outer textile layer may have a weight of less than or equal to about 250 grams per square meter (“gsm”). The outer textile layer may have a weight of from 30 gsm to 250 gsm, or a weight of from 40 gsm to 200 gsm, or a weight of from 40 gsm to 175 gsm, or a weight of from 50 gsm to 175 gsm, or a weight of about 50 gsm, or a weight of from 50 gsm to 172 gsm, or a weight of about 76 gsm, or a weight of from 50 gsm to 170 gsm, or a weight of about 105 gsm, or a weight of from 100 gsm to 180 gsm, or a weight of about 172 gsm.

The outer textile layer may comprise polyester fibers, polyamide fibers, polyolefin fibers, polyphenylene sulfide fibers or a combination thereof. Suitable polyesters can include, for example, polyethylene terephthalate, polytrimethylene terephthalate, polybutylene terephthalate or a combination thereof. Suitable polyamides, can include, for example, nylon 6, nylon, 6,6 or a combination thereof. Suitable polyolefins can include, for example, polyethylene, polypropylene or a combination thereof.

The heat reactive material may be positioned between the outer textile layer and the middle layer.

The heat reactive material may be applied as a continuous layer. The heat reactive material may be applied as a discontinuous layer. The heat reactive material may be applied discontinuously to form a layer of heat reactive material having less than 100% surface coverage. The heat reactive material may be applied in a pattern of discontinuous forms. The heat reactive material may be applied in a dot pattern, grid pattern, line pattern, wave pattern, or any other pattern, or combinations thereof.

The heat reactive material may comprise expandable graphite. The heat reactive material may comprise a polymer resin. The heat reactive material may comprise a mixture of expandable graphite and a polymer resin.

The expandable graphite may expand by at least about 400 microns in the TMA Expansion Test described herein when heated to about 240° C. The expandable graphite may expand by at least about 500 microns in the TMA Expansion Test described herein when heated to about 240° C. The expandable graphite may expand by at least about 600 microns in the TMA Expansion Test described herein when heated to about 240° C. The expandable graphite may expand by at least about 700 microns in the TMA Expansion Test described herein when heated to about 240° C. The expandable graphite may expand by at least about 800 microns in the TMA Expansion Test described herein when heated to about 240° C. The expandable graphite may expand by at least about 900 microns in the TMA Expansion Test described herein when heated to about 280° C.

The expandable graphite may have an average expansion of at least about 4 cubic centimeters per gram (cc/g), or at least about 5 cubic centimeters per gram (cc/g), or at least about 6 cubic centimeters per gram (cc/g), or at least about 7 cubic centimeters per gram (cc/g), or at least about 8 cubic centimeters per gram (cc/g), or at least about 9 cubic centimeters per gram (cc/g), or at least about 10 cubic centimeters per gram (cc/g), or at least about 11 cubic centimeters per gram (cc/g), or at least about 12 cubic centimeters per gram (cc/g), or at least about 19 cubic centimeters per gram (cc/g), or at least about 20 cubic centimeters per gram (cc/g), or at least about 21 cubic centimeters per gram (cc/g), or at least about 22 cubic centimeters per gram (cc/g), or at least about 23 cubic centimeters per gram (cc/g) or at least about 24 cubic centimeters per gram (cc/g), or at least about 25 cubic centimeters per gram (cc/g) at 300° C. when tested using the Furnace Expansion Test described herein. For example, the expandable graphite may have an average expansion of about 19 cc/g at 300° C. when tested using the Furnace Expansion Test described herein.

The expandable graphite may have an endotherm greater than or equal to about 50 J/g, or greater than or equal to about 75 J/g, or greater than or equal to about 100 J/g, or greater than or equal to about 125 J/g, or greater than or equal to about 150 J/g, or greater than or equal to about 175 J/g, or greater than or equal to about 200 J/g, or greater than or equal to about 225 J/g, or greater than or equal to about 250 J/g. Differential Scanning calorimetry (DSC) can be used to determine the endothermic values of the expandable graphite materials.

The heat reactive material may comprise expandable graphite with an average expansion of at least about 4 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 6 cubic centimeters per gram (cc/g) at 300° C. when tested using the Furnace Expansion Test described herein and an endotherm of at least about 100 Joules per gram (J/g) when tested according to the DSC Endotherm Test method described herein. The heat reactive material may comprise expandable graphite with an average expansion of at least about 8 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 9 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 10 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 12 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 14 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 16 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 18 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 19 cubic centimeters per gram (cc/g) at 300° C. when tested using the Furnace Expansion Test described herein and an endotherm of at least about 100 Joules per gram (J/g) when tested according to the DSC Endotherm Test method described herein. Heat reactive materials may comprise expandable graphite with an average expansion of at least about 20 cubic centimeters per gram (cc/g) at 300° C. when tested using the Furnace Expansion Test described herein and an endotherm of at least about 100 Joules per gram (J/g) when tested according to the DSC Endotherm Test method described herein.

Heat reactive materials may comprise expandable graphite with an average expansion of at least about 4 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 6 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 8 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 9 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 10 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 12 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 14 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 16 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 18 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 19 cubic centimeters per gram (cc/g) at 300° C. when tested using the Furnace Expansion Test described herein and an endotherm of at least about 150 Joules per gram (J/g) when tested according to the DSC Endotherm Test method described herein. Heat reactive materials may comprise expandable graphite with an average expansion of at least about 20 cubic centimeters per gram (cc/g) at 300° C. when tested using the Furnace Expansion Test described herein and an endotherm of at least about 150 Joules per gram (J/g) when tested according to the DSC Endotherm Test method described herein.

Heat reactive materials may comprise expandable graphite with an average expansion of at least about 4 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 6 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 8 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 9 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 10 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 12 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 14 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 16 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 18 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 19 cubic centimeters per gram (cc/g) at 300° C. when tested using the Furnace Expansion Test described herein and an endotherm of at least about 200 Joules per gram (J/g) when tested according to the DSC Endotherm Test method described herein. Heat reactive materials may comprise expandable graphite with an average expansion of at least about 20 cubic centimeters per gram (cc/g) at 300° C. when tested using the Furnace Expansion Test described herein and an endotherm of at least about 200 Joules per gram (J/g) when tested according to the DSC Endotherm Test method described herein.

Heat reactive materials may comprise expandable graphite with an average expansion of at least about 4 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 6 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 8 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 9 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 10 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 12 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 14 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 16 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 18 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 19 cubic centimeters per gram (cc/g) at 300° C. when tested using the Furnace Expansion Test described herein and an endotherm of at least about 250 Joules per gram (J/g) when tested according to the DSC Endotherm Test method described herein. Heat reactive materials may comprise expandable graphite with an average expansion of at least about 20 cubic centimeters per gram (cc/g) at 300° C. when tested using the Furnace Expansion Test described herein and an endotherm of at least about 250 Joules per gram (J/g) when tested according to the DSC Endotherm Test method described herein.

Expandable graphite particle size may be chosen so that the heat reactive material may be applied with a selected application method. For example, if the heat reactive material is applied by a gravure printing technique, the expandable graphite particle size should be small enough to fit in the gravure cells.

The heat reactive material may comprise a polymer resin. The polymer resin may have a melt or softening temperature of less than about 280° C. The polymer resin may be sufficiently flowable or deformable to allow the expandable graphite to expand substantially upon heat exposure at or below about 300° C. The polymer resin may be sufficiently flowable or deformable to allow the expandable graphite to expand substantially upon heat exposure at or below about 280° C. The polymer resin may allow the expandable graphite to sufficiently expand at temperatures below the pyrolysis temperature of the meltable outer textile. The extensional viscosity of the polymer resin may be low enough to allow for the expansion of expandable graphite and high enough to maintain the structural integrity of the heat reactive material after expansion of the mixture of polymer resin and expandable graphite. These factors can be quantified by the storage modulus and tan delta of the polymer.

The polymer resin may have a storage modulus of at least about 10³ dyne/cm². The polymer resin may have a storage modulus from 10³ to 10⁸ dyne/cm². The polymer resin may have a storage modulus from 10³ to 10′ dyne/cm². The polymer resin may have a storage modulus from 10³ to 10⁶ dyne/cm². The polymer resin may have a storage modulus from 10³ to 10⁵ dyne/cm². The polymer resin may have a storage modulus from 10³ to 10⁴ dyne/cm². Storage modulus is a measure of a polymer elastic behavior and can be measured using Dynamic Mechanical Analysis (DMA). The polymer resin may have a Tan delta from about 0.1 to about 10 at 200° C. Tan delta is the ratio of the loss modulus to the storage modulus and can also be measured using DMA techniques.

The polymer resins may have a modulus and elongation at around about 300° C. or less, suitable to allow the expandable graphite to expand. The polymer resins may be elastomeric. The polymer resins may be cross-linkable, such as crosslinkable polyurethane. The polymer resins may be thermoplastic. Thermoplastic polymer resins may have a melt temperature from 50° C. to 250° C.

The polymer resin may comprise polymers which include but are not limited to polyesters, polyether, polyurethane, polyamide, acrylic, vinyl polymer, polyolefin, silicone, epoxy or a combination thereof.

The heat reactive material and/or the polymer resin may comprise a flame retardant material. The flame reactardant material may comprise melamine, phosphorous, metal hydroxides such as alumina trihydrate (ATH), borates, or a combination thereof. The flame retardant material may comprise brominated compounds, chlorinated compounds, antimony oxide, organic phosphorous-based compounds, zinc borate, ammonium polyphosphate, melamine cyanurate, melamine polyphosphate, molybdenum compounds, magnesium hydroxide, triphenyl phosphate, resorcinol bis-(diphenylphosphate), bisphenol-A-(diphenylphosphate), tricresyl phosphate, organophosphinates, phosphonate esters or a combination thereof.

If present, the flame retardant materials may be used in a proportion of from 1 percent to 50 percent by weight, based on the total weight of the polymer resin.

The heat reactive material may form a plurality of tendrils comprising expanded graphite upon exposure to the heat from an electrical arc. The total surface area of the heat reactive material may increase significantly when compared to the same mixture prior to expansion. For example, the surface area of the heat reactive material may be increased at least twice, or at least three times, or at least four times, or at least five times, or at least six times, or at least seven times, or at least eight times, or at least nine times, or at least eleven times, or at least twelve times, or at least thirteen times, or at least fourteen times, or at least 15 times after expansion.

Tendrils may extend outward from the expanded heat reactive material. Where the heat reactive material is situated on the layer(s) in a discontinuous form, the tendrils may extend to at least partially fill the open areas between the discontinuous domains of the heat reactive material.

Tendrils may be elongated. Tendrils may have a length to width aspect ratio of at least 5 to 1.

In embodiments in which the heat reactive material comprising a polymer resin-expandable graphite mixture is applied in a pattern of discontinuous forms, the heat reactive material may expand forming tendrils that are loosely packed after expansion creating voids between the tendrils, as well as space between the pattern of the heat reactive material. Without wishing to be bound by theory, upon exposure to the heat from an electric arc, the meltable outer textile melts and generally moves away from the open areas between the discontinuous forms of the heat reactive material.

The heat reactive material may act as the adhesive material between the outer textile layer and the middle layer.

The heat reactive material may be prepared by a method that provides an intimate blend of polymer resin and expandable graphite, without causing substantial expansion of the expandable graphite. The polymer resin and an expandable graphite may be blended to form a mixture that can be applied in a continuous or a discontinuous pattern to either material on a surface interface. A polymer resin and expandable graphite mixture may be prepared by any suitable mixing method. Suitable mixing methods include but not limited to paddle mixer, blending and other low shear mixing techniques.

A polymer resin and expandable graphite mixture may be prepared by mixing the expandable graphite with a monomer or prepolymer prior to polymerization of the polymer resin. A polymer resin and expandable graphite mixture may be prepared by blending the expandable graphite with a dissolved polymer, wherein the solvent is removed after mixing. A polymer resin and expandable graphite mixture may be prepared by mixing expandable graphite with a hot melt polymer at a temperature below the expansion temperature of the graphite and above the melting temperature of the polymer. Without wishing to be bound by theory, a mixture prepared by these methods may comprise an intimate blend of polymer resin and expandable graphite particles.

In methods which provide an intimate blend of polymer resin and expandable graphite particles or agglomerates of expandable graphite, the expandable graphite is coated or encapsulated by the polymer resin prior to expansion of the graphite. The intimate blend of polymer resin and expandable graphite may be prepared prior to applying the heat reactive material to the inner textile layer or the middle layer.

The heat reactive material may comprise less than or equal to about 50 wt %, or less than or equal to about 40 wt %, or less than or equal to about 30 wt %, or less than or equal to about 20 wt %, or less than or equal to about 10 wt %, or less than or equal to about 5 wt %, or greater than or equal to about 1 wt % of the expandable graphite based on the total weight of the heat reactive material, and the balance substantially comprising the polymer resin. Generally, from about 5 wt % to about 50 wt % of expandable graphite based on the total weight of the heat reactive material, is desired. However, desirable flame resistance performance may be achieved with even lower amounts of expandable graphite. In some embodiments, loadings as low as 1% may be useful. Depending on the properties desired and the construction of the resulting laminate structures, other levels of expandable graphite may also be suitable for other embodiments. Other additives such as pigments, fillers, antimicrobials, processing aids and stabilizers may also be added to the heat reactive material.

The heat reactive material may be applied to one or both of the inner surface of the outer textile layer or the outer surface of the middle layer.

The heat reactive material may be applied continuously. The heat reactive material may be applied discontinuously. For example, where enhanced breathability and/or hand is desired, the heat reactive material may be applied discontinuously to form a layer of heat reactive material having less than 100% surface coverage. A discontinuous application of the heat reactive material may provide less than 100% surface coverage.

The heat reactive material may be applied discontinuously in a pattern. The heat reactive material may be applied to the inner textile layer or the middle layer forming a layer of heat reactive material in the form of a multiplicity of discrete pre-expansion structures comprising the heat reactive material. Upon expansion, the discrete pre-expansion structures may form a multiplicity of discrete expanded structures having structural integrity. The multiplicity of discrete expanded structures having structural integrity may provide sufficient protection to a laminate structure to achieve the enhanced properties described herein. By structural integrity it is meant that the heat reactive material after expansion withstands flexing or bending without substantially disintegrating or flaking off the, and withstands compression upon thickness measurement when measured according to the Thickness Change Test described herein.

The heat reactive material may be applied discontinuously in a pattern comprising a multiplicity of discrete pre-expansion structures comprising the heat reactive material. The pattern may include shapes such as dots, circles, romboids, ovals, stars, rectangles, squares, triangles, pentagons, hexagones, octagons, lines, waves, and the like, and combinations thereof.

The average distance between adjacent areas of the discontinuous pattern of the heat reactive material may be less than the size of an impinging flame. The average distance between adjacent areas of discontinuous pattern may be equal or less than about 10 millimeters (mm), or equal or less than about 9 mm, or equal or less than about 8 mm, or equal or less than about 7 mm, or equal or less than about 6 mm, or equal or less than about 5 mm, or equal or less than about 4 mm, or equal or less than about 3.5 mm, or equal or less than about 3 mm, or equal or less than about 2.5 mm or equal or less than about 2 mm, or equal or less than about 1.5 mm, or equal or less than about 1 mm, or equal or less than about 0.5 mm, or equal or less than about 0.4 mm, or equal or less than about 0.3 mm, or equal or less than about 0.2 mm. For example, in a dotted pattern printed of the heat reactive material onto the inner textile layer or the middle layer, the spacing between the edges of two adjacent dots of heat reactive material would be measured. An average distance between adjacent areas of the discontinuous pattern may be equal or greater than about 40 microns, or equal or greater than about 50 microns, or equal or greater than about 100 microns, or equal or greater than about 200 microns, depending on the application. Average dot spacing measured to be equal or greater than about 200 microns and equal or less than about 500 microns is useful in some patterns described herein.

Pitch may be used, for example, in combination with surface coverage as a way to describe the laydown of a printed pattern. In general, pitch is defined as the average center-to-center distances between adjacent forms such as dots, lines, or gridlines of the printed pattern. The average is used, for example, to account for irregularly spaced printed patterns. The heat reactive material may be applied discontinuously in a pattern with a pitch and surface coverage that provides superior flame retardant performance compared to a continuous application of heat reactive mixture having a laydown of equivalent weight of the heat reactive material. The pitch may be defined as the average of the center-to-center distances between adjacent shapes of the heat reactive material. For example, the pitch may be defined as the average of the center-to-center distances between adjacent dots or grid lines of the heat reactive material. The pitch may be equal or greater than about 500 microns, equal or greater than about 600 microns, equal or greater than about 700 microns, equal or greater than about 800 microns, equal or greater than about 900 microns, equal or greater than about 1000 microns, equal or greater than about 1200 microns, equal or greater than about 1500 microns, equal or greater than about 1700 microns, equal or greater than about 1800 microns, equal or greater than about 2000 microns, equal or greater than about 3000 microns, equal or greater than about 4000 microns, or equal or greater than about 5000 microns, or equal or greater than about 6000 microns or any value therebetween. A preferred pattern of heat reactive material may have pitch from about 500 microns to about 6000 microns.

In embodiments where properties such as hand, breathability, and/or textile weight are important, a surface coverage of equal or greater than about 25%, and equal or less than about 90%, or less than about 80%, or less than about 70%, or less than about 60%, or less than about 50%, or less than about 40%, or less than about 30% may be used. Upon exposure to an electric arc, the outer textile layer may be exposed to enough energy to combust. In those embodiments and where greater flame resistant properties are needed, it may be desired to have a surface coverage from about 30% to about 100% of the heat reactive material on a surface of the inner textile or middle layers. Where greater flame resistant properties are needed, it may be desired to have a surface coverage of the heat reactive material with pitch from about 500 microns to about 6000 microns. For example, the surface coverage of the heat reactive material may be from about 30% to about 80% of the heat reactive material on a surface of the inner textile or middle layer with pitch from about 500 microns to about 6000 microns.

A method for depositing the heat reactive material discontinuously on the outer textile layer or the middle layer achieving a coverage of the surface of less than 100% may comprise applying the heat reactive material by printing onto said layer. The deposition of the heat reactive material on the outer textile layer or the middle layer may be achieved by any suitable method, such as gravure printing, screen printing, spray or scatter coating, knife coating, and any like method that enables the heat reactive material to be applied in a manner in which the desired properties upon exposure to the heat from an electrical arc are achieved.

The heat reactive material may be applied on the outer textile layer or the middle layer to achieve an add-on weight of from about 10 gsm to about 100 gsm of the heat reactive material. The heat reactive material may be applied to achieve an add-on weight of equal or less than about 100 gsm, or equal or less than about 75 gsm, or equal or less than about 50 gsm, or equal or less than about 25 gsm of the heat reactive material.

A method of fabricating the laminate structure described herein may comprise applying a layer of heat reactive material on the outer textile layer or on the middle layer in a manner in which the heat reactive material provides a good bond between the middle layer and the outer textile layer. The heat reactive material may function as an adhesive. For example, the heat reactive material may bond the inner side of the outer textile layer and the outer side of the middle layer forming a layer of heat reactive material between the outer textile layer and the middle layer. During the formation of the laminate structure, the heat reactive material may be applied in a continuous or discontinuous manner to the outer textile or to the middle layer. The outer textile layer and the middle layers may then adhered to one another. The outer textile layer and the middle layers may then be adhered to one another by pressure and/or heat, for example by running through the nip of two rollers or heated rollers. If heat is used, the temperature should be low enough so that the heat does not initiate expansion of the expandable graphite. The pressure (e.g. from the nip) may cause at least the polymer resin of the heat reactive material to be disposed at least partially within surface pores, surface voids or voids or spaces between the fibers of one or both of the layers. At least the polymer resin of the heat reactive material may penetrate the voids or spaces between the fibers and/or filaments of the outer textile layer. At least the polymer resin of the heat reactive material may penetrate into the middle layer. At least the polymer resin of the heat reactive material may penetrate the voids or spaces between the fibers of the outer textile material and may penetrate into the middle layer.

The middle layer may comprise a barrier layer. For example, the middle layer may comprise a polyimide, a silicone or a polytetrafluroethylene (PTFE) layer. The middle layer may comprise expanded polytetrafluoroethylene (ePTFE).

The middle layer may be a two-layer film. The two-layer film may comprise (a) a first layer of expanded polytetrafluoroethylene and (b) a second layer of expanded polytetrafluoroethylene. The two-layer film may comprise (a) a first layer of expanded polytetrafluoroethylene and (b) a polyurethane coated expanded polytetrafluoroethylene.

The middle layer may comprise a flame retardant material. The middle layer may be a flame retardant (FR) layer.

The middle layer may be a flame retardant (FR) textile layer. When a textile layer is used as the middle layer, the textile layer may contain a relatively high density of warp and weft fibers or filaments. This can increase the weight and stiffness of the laminate structure.

The middle layer may be a film having a thickness of equal or less than 1 millimeter (mm) and a hand of equal or less than about 100, when measured by the Flexibility or Hand Measurement Test described herein.

The film may comprise materials such as a heat or thermally stable film, and may include materials such as polyimide, silicone, PTFE, such as expanded PTFE. The thermal stability of materials may be assessed with the Melting and Thermal Stability Test described herein.

The middle layer may be a thermally stable barrier layer. In some embodiments, the middle layer is a thermally stable barrier layer, as measured by the Barrier Thermal Stability Test described herein. The middle layer may be more thermally stable than the inner and outer textile layers. A thermally stable barrier layer can help to prevent the heat transfer from the outer side of the laminate structure to the inner side of the laminate structure during exposure to an electrical arc. Thermally stable barrier layers for use as the middle layer in the embodiments described herein, have a maximum air permeability of about 50 liters/meter²/second (l/m²/sec) after thermal exposure when tested according to the air permeability test ISO 9237 (1995). Thermally stable barrier layers for use as the middle layer in the embodiments described herein, are also resistant to forming holes (greater than or equal to 5 millimeters in diameter) after exposure to an electric arc. In other embodiments, the middle layers have a maximum air permeability of less than about 25 l/m²/sec or less than about 15 l/m²/sec, after thermal exposure, when tested according to the air permeability test for thermally stable barrier layer as disclosed herein. Where the middle layer comprises a film, the film may have a maximum air permeability of equal or less than about 25l/m²/sec after thermal exposure when tested as per the Melting and Thermal Stability Test method described herein. Where the middle layer comprises a film, the film may have an air permeability after an electrical arc exposure sufficient to expand the expandable graphite of equal or less than about 15 l/m²/sec, when tested according to the air permeability test for thermally stable barriers as disclosed herein.

The middle layer may have a maximum air permeability of equal or less than about 50 l/m²/sec, or equal or less than about 45 l/m²/sec, or equal or less than about 40 l/m²/sec, or equal or less than about 35 l/m²/sec, or equal or less than about 30 l/m²/sec, or equal or less than about 25 l/m²/sec, or equal or less than about 20 l/m²/sec, or equal or less than about 15 l/m²/sec, or equal or less than about 10 l/m²/sec, or equal or less than about 5 l/m²/sec, after thermal exposure when tested according to the air permeability test for thermally stable barrier layer as disclosed herein.

The middle layer may have a weight in the range of from 10 gsm to 50 gsm, or in the range of from 20 gsm to 50 gsm, or in the range of from 30 gsm to 50 gsm, or in the range of from 40 gsm to 50 gsm, or in the range of from 10 gsm to 40 gsm, or in the range of from 10 gsm to 30 gsm, or in the range of from 10 gsm to 20 gsm, or in the range of from 20 gsm to 40 gsm, or in the range of between 30 gsm and 40 gsm, or in the range of between 20 gsm and 30 gsm, or in the range of between 15 gsm and 35 gsm, or in the range of between 20 gsm and 35 gsm, or in the range of between 25 gsm and 35 gsm, or in the range of between 30 gsm and 35 gsm, or in the range of between 15 gsm and 30 gsm, or in the range of between 25 gsm and 30 gsm, or in the range of between 15 gsm and 25 gsm, or in the range of between 20 gsm and 25 gsm, or in the range of between 15 gsm and 20 gsm, or in the range of between 21 gsm and 23 gsm, or in the range of between 29 gsm and 31 gsm, or any value therebetwen or about 22 gsm, or about 30 gsm.

The flame retardant adhesive material may be sandwiched between the middle layer and the inner layer. The flame retardant adhesive material may comprise a flame retardant additive. The flame retardant adhesive material may comprise a polymer resin.

The flame retardant adhesive material may comprise a polymer resin and a flame retardant additive. The flame retardant adhesive material may comprise one or more polymer resins and one or more flame retardant additives. The flame retardant adhesive material may consist of or consist essentially of one or more polymer resins and one or more flame retardant additives. As used herein, “consists essentially of” means that the composition contains those components listed and less than about 5 percent by weight of any additional component that might materially affect the composition.

The flame retardant adhesive material composition may contain equal or less than about 4%, or equal or less than about 3%, or equal or less than about 2%, or equal or less than about 1%, or equal or less than about 0.5% of any additional component.

Any of the polymer resins described as being useful for the heat reactive material may be used for the flame retardant adhesive, provided that a sufficient amount of flame retardant additive is present. Suitable polymer resins may include, for example, polyesters, polyether, polyurethane, polyamide, acrylic, vinyl polymer, polyolefin, silicone, epoxy or a combination thereof.

The polymer resins may be thermoplastic. Suitable polymer resins may be thermoplastic having a melt temperature from about 50° C. to about 250° C., such as that sold under the trade name DESMOMELT® VP KA 8702, sold by Bayer MaterialScience LLC of Pittsburgh, Pa., USA.

The polymer resins may be crosslinkable. Suitable Polymer resins may include, for example, crosslinkable polyurethane such as that sold under the trade name MOR-MELT™ R7001 E by Rohm & Haas of Philadelphia, Pa., USA.

Flame retardant properties of the flame retardant adhesive material may be provided by the incorporation of a flame retardant additive in the polymer resin. Flame retardant additives may include, for example, one or more of brominated compounds, chlorinated compounds, antimony oxide, organic phosphorous-based compounds, zinc borate, ammonium polyphosphate, melamine cyanurate, melamine polyphosphate, molybdenum compounds, magnesium hydroxide, triphenyl phosphate, resorcinol bis-(diphenylphosphate), bisphenol-A-(diphenylphosphate), tricresyl phosphate, organophosphinates, phosphonate esters or a combination thereof. The flame retardant additives may be used in a proportion of from 1% to 10%, or 1% to 15%, or 1% to 20%, or 1% to 30% or 1% to 35%, or 1% to 40%, or 1% to 50%, or 10% to 40%, or 10% to 40%, or 10% to 30%, or 10% to 20%, or 10% to 15%, or 20% to 50%, or 20% to 40% or 20% to 30% or 20% to 25%, or 30% to 50%, or 30% to 40%, or 30% to 35%, or 40% to 50%, or 45% to 50%, or 40% to 45% by weight, based on the total weight of the polymer resin.

The flame retardant adhesive material may bond the middle layer and the inner layer. The flame retardant adhesive material may be applied discontinuously. The flame retardant adhesive material may be applied discontinuously to form a layer of flame retardant adhesive material. The flame retardant adhesive material may be applied discontinuously in a pattern having less than 100%, or equal or less than about 95%, or equal or less than about 90%, or equal or less than about 80%, or equal or less than about 75%, or equal or less than about 70%, or equal or less than about 65%, or equal or less than about 60%, or equal or less than about 55%, or equal or less than about 50%, or equal or less than about 45%, or equal or less than about 30% surface coverage across the surface of the middle layer and the inner layer. For example, the flame-retardant adhesive material may cover less than 75% of outer surface of the inner layer.

For example, the flame retardant adhesive material may be positioned in a pattern so as to form a plurality of pockets, each of the pockets defined by (a) the middle layer, (b) the inner layer, and (c) a portion of the flame retardant adhesive material, and wherein the pattern covers less than 75% of the inner layer.

The flame retardant adhesive material may be applied in a pattern. The flame retardant adhesive material may be applied discontinuously in a grid-like pattern, dotted pattern, wave pattern, line pattern, or any regular or irregular shape, for example, dots, circles, squares, rectangles, romboids, ovals, pentagons, hexagons, octagons, stars, lines, or any polygon or irregular shapes.

The pattern of flame retardant adhesive material may define a plurality of pockets. The pockets may represent regions where the middle layer and the inner layer are not bonded to each other. Specifically, the pockets may be non-bonded areas wherein the middle layer and the inner layer are able to contact one another, but are separable from one another. Each of the pockets may be formed by and bounded or surrounded by the flame retardant adhesive material, the middle layer and the inner layer. The flame retardant adhesive material may bond the middle layer and the inner layer in those areas defined by the pattern of flame retardant adhesive material, while the pockets may define non-bonded regions where the middle layer and the inner layer are not bonded to each other.

The pockets themselves may be free from the flame retardant adhesive material or the pockets may be essentially free from the flame retardant adhesive material. As used here, the phrase “essentially free from” means that the non-bonded region contains less than about 5%, or less than about 4% or less than about 3%, or less than about 2% or less than about 1%, or less than about 0.5% of the flame retardant adhesive, when measuring the area of the pocket. A relatively weak adhesive composition may ‘temporarily’ adhere the middle layer and the inner layer so that the middle and inner layers do not separate under ordinary use. However, during exposure to an electrical arc, the energy from the electrical arc should be sufficient to melt or degrade the weak adhesive composition in the pocket region thereby allowing the separation of the middle layer and the inner layer and the expansion of the pocket as described herein.

The pattern may be applied as solid lines of the flame retardant adhesive material. The pattern may be applied as lines that comprise a series of closely spaced dots or shapes of the flame retardant adhesive material. For example, the flame retardant adhesive may be applied as a series of dots or shapes each having an average diameter in the range of about 0.3 to about 2.0 millimeters (mm) and an average center to center spacing (pitch) between adjacent dots in the range of about 0.4 to about 3.0 mm. The pattern may be any regularly repeating pattern that defines the pocket. The pattern may be a grid pattern forming rectangular/square pockets. The pattern may be a series of sinusoidal lines wherein the sinusoidal waves travel in a first direction and are spaced from one another in a second direction that is perpendicular to the first direction. The series of sinusoidal lines may be offset from one another along the first direction to an extent such that the peak of one of the sinusoidal waves is aligned with the trough of an adjacent sinusoidal wave. The peaks and troughs of the sinusoidal lines may touch. The peaks and troughs of the sinusoidal lines may overlap. The sinusoidal lines or waves may define a bonded area or pattern and a non-bonded area or pocket. For example, the pattern may comprise a series of parallel sinusoidal lines, the sinusoidal lines being offset from one another such that a peak of a first one of the sinusoidal lines is aligned with a trough of an adjacent one of the sinusoidal lines.

Other regularly repeating patterns can be used. For example, a pattern of circles, of rectangles, of pentagons, of hexagons, of polygons may be used. Adjacent polygons or shapes may share a common (adjacent) edge. Adjacent polygons or shapes may have edges independent of one another. If the polygons or other shapes are independent from one another and there is a non-bonded region in between adjacent edges, care should be taken that the distance between adjacent edges is kept relatively small, for example, less than or equal to about 5 mm, or less than or equal to about 4 mm, or less than or equal to about 3 mm, or less than or equal to about 2 mm, or less than or equal to about 1 mm, or less than or equal to about 0.5 mm. Regularly repeating polygons each may share a common side with the adjacent polygon. The pattern may have relatively small openings. For example, a circular pattern may have a relatively small opening, so that the pattern of the flame retardant adhesive resembles the letter “C”. The opening should be kept as small as possible. The pattern may be a continuous pattern with no openings. A continuous pattern with no openings may define the perimeter of a closed shape (e.g. a circle, a square, a rectangle or any other regular or irregular shape). The perimeter of the pattern or shape may be defined by flame resistant adhesive material. The interior of the shape or pattern defined by flame resistant adhesive material may not comprise flame resistant adhesive material. The interior of the shape or pattern defined by flame resistant adhesive material may define a pocket.

The pockets represent unbonded areas between the middle layer and the inner layer. The pockets may have an area that is in the range of from a minimum of about 25 millimeters' (mm²) to a maximum of about 22,500 mm², or from about 25 mm² to about 22,000 mm², or from about 30 mm² to about 22,000 mm², or from about 35 mm² to about 22,0000 mm², or from about 40 mm² to about 22,000 mm², or from about 45 mm² to about 22,000 mm², or from about 50 mm² to about 22,000 mm², or from about 75 mm² to about 22,000 mm², or from about 100 mm² to about 22,000 mm², or from about 100 mm² to about 20,000 mm², or from about 100 mm² to about 15,000 mm², or from about 100 mm² to about 10,000 mm², or from about 100 mm² to about 9,000 mm², or from about 100 mm² to about 8,000 mm², or from about 100 mm² to about 7,000 mm², or from about 100 mm² to about 6,000 mm², or from about 100 mm² to about 5,000 mm², or from about 100 mm² to about 4,000 mm², or from about 100 mm² to about 3,000 mm², or from about 100 mm² to about 2,000 mm², or from about 100 mm² to about 1,000 mm², or from about 100 mm² to about 900 mm², or from about 100 mm² to about 800 mm², or from about 100 mm² to about 700 mm², or from about 100 mm² to about 600 mm², or from about 100 mm² to about 500 mm², or from about 100 mm² to about 400 mm², or from about 100 mm² to about 300 mm², or from about 100 mm² to about 200 mm², or from about 100 mm² to about 150 mm².

The area of a pocket refers to the average area of the individual pockets of the laminate structure. If the laminate structure includes pockets of different shapes and/or sizes, then at least about 80% of the pockets should have an area that is in the range of from about 25 mm² to about 22,500 mm². Where the pattern is made of shapes having no common edges, only the areas of the pockets are used to calculate the pocket area. As the distance between adjacent edges gets larger, this may require that the area of the pockets be larger. For example, if a regular repeating pattern of square pockets having an area of about 50 mm² is used, then the distance between the edges of adjacent square pockets should be as small as possible. The distance between the edges of adjacent pockets may be equal or less than 2 mm or equal or less than 1 mm.

The flame retardant adhesive material may be applied using known lamination techniques that can be used to produce the desired pattern, for example, gravure printing, screen printing or ink jet printing, using adhesive scrims and the like. The flame retardant adhesive material may be positioned (or applied) so as to form a plurality of pockets, each of the pockets defined by (a) the middle layer, (b) the inner layer and (c) a portion of the flame retardant adhesive material, and wherein the pattern covers less than 75% of the outer surface of the inner layer. The flame retardant adhesive material may be applied in a pattern on the middle layer and/or the inner layer. The pattern may comprise a grid pattern including a first series of parallel lines oriented in a first direction and a second series of parallel lines oriented in a second direction, the first direction and the second direction being offset from one another at an angle that is in the range of between 30 degrees and 90 degrees. The flame retardant adhesive material may be applied as a grid-like pattern having a first series of parallel lines and a second series of parallel lines that are oriented about 90 degrees relative to the first series of parallel lines. The flame retardant adhesive material may be applied using a gravure roll, or any other suitable deposition technique.

The inner layer may be an inner textile layer which may be produced from any known textile fiber or filament. The inner textile layer may comprise flame retardant fibers, non-flame retardant fibers, synthetic fibers, natural fibers or a combination thereof. The inner textile layer may be a woven, knit or nonwoven textile. The knit may be a circular knit, a flat knit, a warp knit or a Raschel knit.

Where the inner textile layer comprises flame retardant textile or fibers, the flame retardant textiles may include textiles produced from p-aramid, m-aramid, polybenzimidazole, polybenzoxazole, polyetheretherketone, polyetherketoneketone, polyphenyl sulfide, polyimide, melamine, fluoropolymer, polytetrafluoroethylene, modacrylic, cellulose, FR viscose, polyvinylacetate, mineral, protein fibers, or a combination thereof.

Where the inner textile layer comprises a non flame-retardant textile, the non-flame retardant textile may comprise synthetic fibers, natural fibers or textiles that comprise both synthetic and natural fibers. Suitable synthetic textiles may include, for example, polyesters, polyamides, polyolefins, acrylics, polyurethanes or a combination thereof. Suitable natural fibers may include, for example, cotton, wool, cellulose, animal hair, jute, hemp or any other naturally occurring fiber. Combinations thereof may also be used.

In some embodiments, a small proportion, for example, less than 10% by weight of antistatic fibers or filaments may be added to the textile, wherein the percentage by weight is based on the total weight of the textile. Suitable antistatic fibers/filaments are known in the art and can include, for example, conductive metals, copper, nickel, stainless steel, steel, gold, silver, titanium, carbon fibers. In still further embodiments, the inner textile layer can comprise a small percentage of elastic filaments. Suitable filaments can include, for example, polyurethane, elastane, spandex, silicone, rubber or a combination thereof.

The inner layer may comprise a woven, a knit or a nonwoven textile having a weight in the range of from 15 gsm to 450 gsm, or from 20 gsm to 450 gsm, or from 25 gsm to 450 gsm, or from 15 gsm to 400 gsm, or from 20 gsm to 400 gsm, or from 25 gsm to 400 gsm, or from 15 gsm to 375 gsm, or from 20 gsm to 375 gsm, or from 25 gsm to 375 gsm, or from 15 gsm to 350 gsm, or from 20 gsm to 350 gsm, or from 25 gsm to 350 gsm, or from 15 gsm to 325 gsm, or from 20 gsm to 325 gsm, or from 25 gsm to 325 gsm, or from 15 gsm to 300 gsm, or from 20 gsm to 300 gsm, or from 25 gsm to 300 gsm, or from 15 gsm to 275 gsm, or from 20 gsm to 275 gsm, or from 25 gsm to 275 gsm, or from 15 gsm to 250 gsm, or from 20 gsm to 250 gsm, or from 25 gsm to 250 gsm, or from 15 gsm to 225 gsm, or from 20 gsm to 225 gsm, or from 25 gsm to 225 gsm, or from 15 gsm to 200 gsm, or from 20 gsm to 200 gsm, or from 25 gsm to 200 gsm, or from 20 gsm to 250 gsm, or from 30 gsm to 250 gsm, or from 40 gsm to 250 gsm, or from 50 gsm to 250 gsm, or from 50 gsm to 200 gsm, or from 50 gsm to 190 gsm, or from 50 gsm to 180 gsm, or from 50 gsm to 170 gsm, or from 50 gsm to 160 gsm, or from 50 gsm to 150 gsm, or from 50 gsm to 140 gsm, or from 50 gsm to 130 gsm, or from 50 gsm to 120 gsm, or from 50 gsm to 110 gsm, or from 50 gsm to 100 gsm, or from 50 gsm to 90 gsm. For example, the inner layer may have a weight in a range from 20 gsm to 250 gsm.

The inner layer may comprise a quantity of meltable fibers in a range from 1 to 50 percent by weight. The inner layer may comprise a quantity of meltable fibers in a range from 1 to 25 percent by weight. The inner layer may comprise a quantity of meltable fibers in a range from 1 to 10 percent by weight. The inner layer may comprise a quantity of meltable fibers in a range from 25 to 50 percent by weight.

The inner layer may be a textile layer wherein the textile layer comprises a flame retardant textile, or a textile comprising both flame retardant and meltable fibers. The inner layer may be a woven textile that is produced from an aramid and a flame retardant viscose. The inner layer may comprise a woven aramid and flame retardant viscose textile including about 50% aramid and about 50% viscose. The inner layer may comprise a woven aramid and flame retardant viscose textile having a weight of from about 50 gsm to about 250 gsm.

The inner layer may comprise a polyethylene terephthalate (“PET”) interlock textile. The inner layer may comprise a PET knit textile having a weight of from about 50 gsm to 200 gsm, from 50 gsm to 200 gsm, or from 100 gsm to 200 gsm, or from 150 gsm to 200 gsm, or from 50 gsm to 100 gsm, or from 50 gsm to 150 gsm. The inner layer may be a PET knit textile having a weight of from 50 to 200 gsm and about 5 percent or less of antistatic fibers. The inner layer may comprise a modacrylic/cotton blend (MAC/CO) knit textile. The inner layer may comprises a MAC/CO knit textile having a weight of from about 50 gsm to 200 gsm, or from 100 gsm to 200 gsm, or from 150 gsm to 200 gsm, or from 50 gsm to 100 gsm, or from 50 gsm to 150 gsm. The inner layer may comprise a MAC/CO knit textile further comprising about 5 percent or less of antistatic fibers and having a weight of from about 100 gsm to 200 gsm. The inner layer may be a modacrylic knit. The inner layer may be a modacrylic knit having a weight of from about 50 gsm to 200 gsm. The inner layer may be a modacrylic knit having a weight of from 50 gsm to 200 gsm and about 5 percent or less of antistatic fibers.

The laminate structure may have a total weight of less than or equal to about 500 gsm, or less than or equal to about 400 gsm, or less than or equal to about 375 gsm, or less than or equal to about 350 gsm, or less than or equal to about 325 gsm, or less than or equal to about 300 gsm or less than or equal to about 275 gsm, or less than or equal to about 250 gsm, or less than or equal to about 225 gsm, or less than or equal to about 200 gsm, or less than or equal to about 150 gsm, or less than or equal to about 100 gsm, or less than or equal to about 50 gsm.

The laminate structure may have a total thickness in the range of from 0.5 mm to 2.5 mm, from 0.5 mm to 2.0 mm, from 0.5 mm to 1.5 mm, from 0.5 mm to 1.0 mm, from 0.5 mm to 0.7 mm, or about 0.6 mm, or about 0.7 mm, or about 0.8 mm, or about 0.9 mm, or about 1.0 mm, or about 1.2 mm, or about 1.4 mm, or about 1.6 mm, or about 1.8 mm, or about 2.0 mm. Thickness can be determined by ISO 5084 (1996).

The laminate structure may provide a user with protection from exposure to an electric arc, also called “arc flash protection”. The laminate structure may provide arc flash protection satisfying the EN standards EN 61482-1-1:2014 and/or EN 61482-1-2:2014 in both panel form and in garment form. The laminate structure may provide class 2 arc flash protection and satisfy the EN standard EN 61482-1-2:2014. To satisfy the EN standard EN 61482-1-2:2014, the laminate structure that is exposed to an arc flash as defined in the EN standard EN 61482-1-2:2014 while in panel form may provide one or more of the following criteria: have a plot of transmitted incident energy against time that is less than the standard known as the Stoll Curve; an afterflame time that is less than or equal to 5 seconds; or the size of any holes formed must be less than or equal to 5 millimeters.

An article (e.g. garment) comprising the laminate structure that is exposed to an arc flash as defined in the EN standard EN 61482-1-2:2014 while in panel form may provide an article that can have one or more of the following criteria; an afterflame time that is less than or equal to 5 seconds; the size of any holes formed must be less than or equal to 5 millimeters; or the article must display no melting or dripping; or the front zipper of the garment must open easily.

When a laminate structure as described herein is exposed to an electrical arc, such as that applied in accordance with the standards EN 61482-1-1:2014 and/or EN 61482-1-2:2014, portions of the laminate structure may expand and bow away from one another. Upon exposure to an electrical arc, the outer textile layer may melt and the heat reactive material may expand. As the heat reactive material expands, the expanding heat reactive material may absorb the melted or melting outer textile layer thereby preventing the outer textile layer from sustaining a flame and also preventing the outer textile layer from dripping. Upon exposure to an electrical arc, the layer of heat reactive material may expand due to the presence of expandable graphite. Upon exposure to an electrical arc, the pockets defined by the middle layer, the inner layer and the flame retardant adhesive material may expand so that the middle layer and the inner layer separate from each other, thereby forming air gaps.

Upon the application of an arc flash, the laminate structure may include expanded regions overlaying the pockets. The expanded regions may form air gaps within the laminate structure. The air gaps may provide improved insulation and improve the performance of the laminate structure in testing such as testing against the Stoll Curve as described herein. The insulation provided by the expanded regions may enable the laminate to comply with the standards EN 61482-1-1:2014 and/or EN 61482-1-2:2014 while including layers of material of lighter weight than laminate structures including the same or similar materials but lacking a pattern including the bonded area and the pocket that are operative to produce the expanded regions as described above.

The laminate structure may comply with the standards EN 61482-1-1:2014 and/or EN 61482-1-2:2014 and have a weight of less than or equal to 500 gsm. The laminate structure may comply with the standards EN 61482-1-1:2014 and/or EN 61482-1-2:2014 and have a weight of less than or equal to 475 gsm. The laminate structure may comply with the standards EN 61482-1-1:2014 and/or EN 61482-1-2:2014 and have a weight of less than or equal to 450 gsm. The laminate structure may comply with the standards EN 61482-1-1:2014 and/or EN 61482-1-2:2014 and have a weight of less than or equal to 425 gsm. The laminate structure may comply with the standards EN 61482-1-1:2014 and/or EN 61482-1-2:2014 and have a weight of less than or equal to 400 gsm. The laminate structure may comply with the standards EN 61482-1-1:2014 and/or EN 61482-1-2:2014 and have a weight of less than or equal to 375 gsm. The laminate structure may comply with the standards EN 61482-1-1:2014 and/or EN 61482-1-2:2014 and have a weight of less than or equal to 350 gsm. The laminate structure may comply with the standards EN 61482-1-1:2014 and/or EN 61482-1-2:2014 and have a weight of less than or equal to 325 gsm. The laminate structure may comply with the standards EN 61482-1-1:2014 and/or EN 61482-1-2:2014 and have a weight of less than or equal to 300 gsm. The laminate structure may comply with the standards EN 61482-1-1:2014 and/or EN 61482-1-2:2014 and have a weight of less than or equal to 275 gsm. The laminate structure may comply with the standards EN 61482-1-1:2014 and/or EN 61482-1-2:2014 and have a weight of less than or equal to 265 gsm.

The laminate structure may resist shrinkage upon exposure to an electrical arc. The laminate structure may shrink less than about 10%, or less than about 9%, or less than about 8%, or less than about 7%, or less than about 5%, or less than about 4%, or less than about 3%, or less than about 2%, or less than about 1% when tested according to a thermal shrinkage test disclosed herein.

The laminate structure may have a moisture vapor transmission rate (“MVTR”) equal to or greater than about 1000 g/m²/day, equal to or greater than about 2000 g/m²/day, or equal to or greater than about 3000 g/m²/day, or equal to or greater than about 4000 g/m²/day, or equal to or greater than about 5000 g/m²/day, or equal to or greater than about 6000 g/m²/day, or equal to or greater than about 7000 g/m²/day, or equal to or greater than about 8000 g/m²/day, or equal to or greater than about 9000 g/m²/day, or equal to or greater than about 10000 g/m²/day, or equal or greater than about 11000 g/m²/day, or equal or greater than about 12000 g/m²/day, or higher, as tested in accordance with the MVTR test described below.

The laminate structure may have RET values from 1 to 20, from 1 to 19, from 1 to 18, from 1 to 17, from 1 to 16, from 1 to 15, from 1 to 14, from 1 to 13, from 1 to 12, from 1 to 11, from 1 to 10, from 1 to 9, from 1 to 8, from 1 to 7, from 1 to 6, from 1 to 5, from 1 to 4, from 1 to 3, from 1 to 2. The garment may have RET values of about 6, about 6.5, about 7, about 7.5, about 8, about 8.5, about 9, about 9.5, about 10, about 10.5, about 11, about 11.5, about 12, about 12.5, about 13, about 13.5, or about 14.

The laminate structure may have a break open time greater than about 50 seconds, greater than about 60 seconds, greater than about 70 seconds, greater than about 80 seconds, greater than about 90 seconds, greater than about 100 seconds, greater than about 110 seconds, or even greater than 120 seconds when tested according to the methods for Horizontal Flame Test performed using EN ISO 15025, method A1, described herein.

The laminate structure may have an afterflame equal or less than about 20 seconds, or equal or less than about 15 seconds, or equal or less than about 14 seconds, or equal or less than about 13 seconds, or equal or less than about 12 seconds, or equal or less than about 11 seconds, or equal or less than about 10 seconds, or equal or less than about 9 seconds, or equal or less than about 8 seconds, or equal or less than about 7 seconds, or equal or less than about 6 seconds, or equal or less than about 5 seconds when tested according to the Horizontal Flame Test described herein.

The laminate structure may exhibit substantially no melt dripping behavior when tested in the Horizontal Flame test described herein.

The laminate structure may comprise a coating of a durable water repellant material. The durable water repellant material may comprise a fluorocarbon-based water repellant material, a silicon-based water repellant material, a hydrocarbon-based water repellant material, a fluoropolymer-based water repellant material, or any combination thereof. For example, the laminate may comprise a coating of a durable water repellant material on the outer surface of the outer textile layer.

The laminate structure may be used as a garment, wherein the garment is configured such that the inner layer faces a wearer when the garment is worn by the wearer. Suitable garments can include, for example, jackets, shirts, pants, coveralls, gloves, head coverings, leg coverings, aprons, footwear or a combination thereof. The garments can be the outermost layer worn by a wearer or can be underwear, intended to be covered by another garment. Typically, however, the garment is the outermost garment.

The garment may be configured such that the inner layer faces a wearer when the garment is worn by the wearer. The garment may be configured such that the outer textile layer faces the environment when the garment is worn by the wearer. The laminate structure may comprise any of the features defined herein, whether alone or in combination. The laminate structure may have any individual properties disclosed herein, and/or any combination thereof.

In another aspect, the present disclosure relates to a method of manufacturing a laminate structure as described herein, the method comprising the steps of:
providing an outer textile layer and a middle layer and applying a layer of heat reactive material on the outer textile layer and/or on the middle layer;
sandwiching the heat reactive layer between the inner surface of the outer textile layer and the outer surface of the middle layer, such that the heat reactive material bonds the middle layer to the outer textile layer;
applying flame retardant adhesive material in a pattern to an inner side of the middle layer and/or an outer surface of an inner layer; and
sandwiching the flame retardant adhesive material between the inner surface of the middle layer and the outer surface of the inner layer, such that the flame retardant adhesive material bonds the inner layer to the middle layer and a plurality of pockets are formed, each of the pockets defined by (a) the middle layer, (b) the inner layer, and (c) a portion of the flame retardant adhesive material.

The method may comprise applying pressure and/or heat between the middle layer and inner layer (e.g. to the laminate structure, or to the structure comprising the middle layer, inner layer and flame retardant adhesive material), such that the flame retardant adhesive material bonds the inner side of the middle layer and an outer side of the inner layer.

The method may comprise applying pressure and/or heat between the outer textile layer and the middle layer (e.g. to the structure comprising the outer textile layer, the heat reactive material and the middle layer, or to the laminate structure) such that the heat reactive material bonds the inner side of the outer textile layer and the outer side of the middle layer. If heat is applied, the heat should be low enough so that it does not initiate the expansion of the expandable graphite.

The method may comprise applying a durable water repellent coating on the outer textile layer.

The method may comprise sandwiching the heat reactive material between the inner surface of the outer textile layer and the outer surface of the middle layer, such that the heat reactive material bonds the middle layer to the outer textile layer; and then applying the flame retardant adhesive material in a pattern and sandwiching the flame retardant adhesive material between the inner surface of the middle layer and the outer surface of the inner layer, such that the flame retardant adhesive material bonds the inner layer to the middle layer.

As described above, the heat reactive material may be applied in a continuous or discontinuous manner to the outer textile and/or to the middle layer.

As described above, the flame retardant adhesive material may be applied in a continuous or discontinuous manner to the inner textile and/or to the middle layer.

Pressure may be applied by any suitable method. For example, pressure to the laminate may be applied by means of the nip of two rollers. The pressure (e.g. from the nip) may cause at least the polymer resin of the heat reactive material to be disposed at least partially within surface pores, surface voids or voids or spaces between the fibers of one or both of the layers. At least the polymer resin of the heat reactive material may penetrate the voids or spaces between the fibers and/or filaments of the outer textile layer. At least the polymer resin of the heat reactive material may penetrate into the middle layer. At least the polymer resin of the heat reactive material may penetrate the voids or spaces between the fibers of the outer textile material and may penetrate into the middle layer.

Stretch may be incorporated into the laminate structure which can increase the comfort of a garment comprising the laminate structure. One-way stretch can be incorporated, for example, following the disclosure of WO 2018/067529, the disclosure of which is herein incorporated by reference in its entirety. As used herein, one way stretch means that the laminate structure has recoverable elasticity in one of the machine or transverse direction, but typically, not both. Other methods for incorporating stretch into laminate structures, especially those that contain one or more layers that are not inherently elastic are known in the art. Suitable examples can include for example, the teachings of EP 110626 and EP 1852253, the disclosures of which are herein incorporated by reference, in their entireties.

The present disclosure also relates to the use of the laminate structure in manufacturing of a garment, wherein the laminate structure has a total weight that is less than or equal to about 500 gsm.

The disclosure also relates to the use of the laminate structure in manufacturing of a garment, wherein the laminate structure has a total weight that is less than or equal to about 500 gsm and wherein the laminate structure satisfies an EN 61482-1-2:2014 standard.

The laminate may comprise a middle layer sandwiched between the outer textile layer and the inner layer.

The laminate may comprise a heat reactive material sandwiched between the outer textile layer and the middle layer. The heat reactive material may be an adhesive material. The heat reactive material may bond the outer textile layer and the middle layer.

The laminate structure may comprise an adhesive material between the middle layer and the inner layer. The adhesive material may be a flame retardant adhesive material. The adhesive material may bond the middle layer and the inner layer. The adhesive material may be positioned in a pattern so as to form a plurality of pockets, each of the pockets defined by (a) the middle layer, (b) the inner layer, and (c) a portion of the adhesive material.

It should be understood that further features disclosed in connection with each aspect or embodiment correspond to further features of each other aspect or embodiment of the invention. For example, the method may include such steps to make a laminate material in accordance with the first aspect and so may include any material preparation, coating, or fabrication methods disclosed in connection therewith. Moreover the invention extends to any laminate structure obtainable by the methods disclosed herein.

The laminate structure provides excellent lightweight protective garments that can protect a wearer against exposure to arc flash. When the laminate structure is exposed to an electrical arc, the laminate structure may undergo many changes in order to shield the wearer from injury. The outer textile may melt while the heat reactive material expands, absorbing the heat energy and the melting textile, in order to keep the meltable textile from burning and dripping onto the wearer. As the heat energy of the electrical arc moves through the garment, the heat may cause the regions comprising the non-adhered regions between the middle and inner layers to separate or expand (puffing), thereby providing an extra insulative effect. The combination of the melting of the outer textile layer, the expansion of the heat reactive material and the puffing between the middle and inner layers allows for a relatively lightweight laminate structure that is able to provide excellent comfort to a wearer and still provide protection from arc flash exposure.

### BRIEF DESCRIPTION OF THE DRAWINGS

FIG. 1A is a schematic illustration of a cross-section of an exemplary laminate structure.

FIG. 1B is an illustration of a portion of a grid-like pattern of dots in which a flame retardant adhesive material can be applied between a middle layer and an inner layer in accordance with an exemplary embodiment.

FIG. 1C is an illustration of pattern of dots in which a heat reactive material may be applied between an outer textile layer and a middle layer in accordance with an exemplary embodiment.

FIG. 2A is an illustration of a pattern of dots in which a heat reactive material may be applied between an outer textile layer and a middle layer in accordance with an exemplary embodiment.

FIG. 2B is an illustration of a grid pattern in which a flame retardant adhesive material may be applied between a middle layer and an inner layer in accordance with an exemplary embodiment.

FIG. 3A is a close up illustration of a pattern of dots from FIG. 3B in which a flame retardant adhesive material may be applied between a middle layer and an inner layer in accordance with an exemplary embodiment.

FIG. 3B is an illustration of a grid pattern in which a flame retardant adhesive material may be applied between a middle layer and an inner layer in accordance with an exemplary embodiment.

FIG. 3C is a photograph of an exemplary laminate structure including a flame retardant adhesive material applied in a grid pattern as shown in FIG. 3B.

FIG. 3D is an illustration of a pattern of sinusoidal waves in which a flame retardant adhesive material may be applied between a middle layer and an inner layer in accordance with an exemplary embodiment.

FIG. 4A is a photograph of a laminate structure in accordance with an exemplary embodiment.

FIG. 4B is a photograph of the laminate structure of FIG. 4A after the application of an electrical arc flash.

FIG. 5 is a plot of transmitted incident energy against time during a first testing of a first exemplary laminate (Laminate Example 1) structure as compared to a Stoll Curve.

FIG. 6 is a plot of transmitted incident energy against time during a first testing of a second exemplary laminate (Laminate Example 2) structure as compared to a Stoll Curve.

FIG. 7 is a plot of transmitted incident energy against time during a first testing of a third exemplary laminate (Laminate Example 3) structure as compared to a Stoll Curve.

FIG. 8 is a plot of transmitted incident energy against time during a first testing of a fourth exemplary laminate (Laminate Example 4) structure as compared to a Stoll Curve.

FIG. 9 is a plot of transmitted incident energy against time during a first testing of a fifth exemplary laminate (Laminate Example 5) structure as compared to a Stoll Curve.

FIG. 10 is a plot of transmitted incident energy against time during a first testing of a sixth exemplary laminate (Laminate Example 8) structure as compared to a Stoll Curve.

FIG. 11 is a plot of transmitted incident energy against time during a first testing of a comparative laminate (Comparative Example E) structure as compared to a Stoll Curve.

FIG. 12A is an illustration of a portion of a first pattern of flame retardant adhesive material between a middle layer and an inner layer in accordance with exemplary embodiments.

FIG. 12B is an illustration of a portion of a second pattern of flame retardant adhesive material between a middle layer and an inner layer in accordance with exemplary embodiments.

FIG. 12C is an illustration of a portion of a third pattern of flame retardant adhesive material between a middle layer and an inner layer in accordance with exemplary embodiments.

FIG. 12D is an illustration of a portion of a fourth pattern of flame retardant adhesive material between a middle layer and an inner layer in accordance with exemplary embodiments.

FIG. 12E is an illustration of a portion of a fifth pattern of flame retardant adhesive material between a middle layer and an inner layer in accordance with exemplary embodiments.

FIG. 12F is an illustration of a portion of a sixth pattern of flame retardant adhesive material between a middle layer and an inner layer in accordance with exemplary embodiments.

### DETAILED DESCRIPTION

The present invention will be further explained with reference to the attached drawings, wherein like structures are referred to by like numerals throughout the several views. The drawings shown are not necessarily to scale, with emphasis instead generally being placed upon illustrating the principles of the present invention. Further, some features may be exaggerated to show details of particular components.

The figures constitute a part of this specification and include illustrative embodiments of the present invention and illustrate various objects and features thereof. Further, the figures are not necessarily to scale, some features may be exaggerated to show details of particular components. In addition, any measurements, specifications and the like shown in the figures are intended to be illustrative, and not restrictive. Therefore, specific structural and functional details disclosed herein are not to be interpreted as limiting, but merely as a representative basis for teaching one skilled in the art to variously employ the present invention.

Among those benefits and improvements that have been disclosed, other objects and advantages of this invention will become apparent from the following description taken in conjunction with the accompanying figures. Detailed embodiments of the present invention are disclosed herein; however, it is to be understood that the disclosed embodiments are merely illustrative of the invention that may be embodied in various forms. In addition, each of the examples given in connection with the various embodiments of the invention which are intended to be illustrative, and not restrictive.

Throughout the specification and claims, the following terms take the meanings explicitly associated herein, unless the context clearly dictates otherwise. The phrases “in one embodiment” and “in some embodiments” as used herein do not necessarily refer to the same embodiment(s), though they may. Furthermore, the phrases “in another embodiment” and “in some other embodiments” as used herein do not necessarily refer to a different embodiment, although they may. Thus, as described below, various embodiments of the invention may be readily combined, without departing from the scope or spirit of the invention.

The term “based on” is not exclusive and allows for being based on additional factors not described, unless the context clearly dictates otherwise. In addition, throughout the specification, the meaning of “a,” “an,” and “the” include plural references. The meaning of “in” includes “in” and “on.”

As used herein, the term “pocket” refers to a non-adhered or non-bonded region of the laminate structure, wherein a pocket is defined by the middle layer, the inner layer and a portion of the flame retardant adhesive material.

The terms “fiber” and “filament” are used interchangeably herein. Fibers and filaments have a relatively small width and height compared to their length. The cross-section of fibers and filaments can be round, square or virtually any shaped, including those having one or more lobes, and are well-known in the art. Typically, a fiber has a relatively short length, for example, less than or equal to 30 centimeters, while a filament has a length greater than 30 centimeters and can essentially be endless, for example, thousands of meters long.

The terms “inner” and “outer” when used to describe layers of the laminate structure are intended to denote the positions of the layers relative to one another and to the middle layer and are based on the placement of the individual layers in a finished article. In a finished article, for example, a garment, such as a jacket, the outer textile layer is meant to be the outermost layer of the garment, whereas the inner layer is meant to be the innermost layer, closest to the body of a wearer.

As used herein, moisture vapor transmission rate (MVTR) is the measure of how much water vapour can pass through a square metre of a membrane within 24 hours. The greater the MVTR is, the higher the breathability.

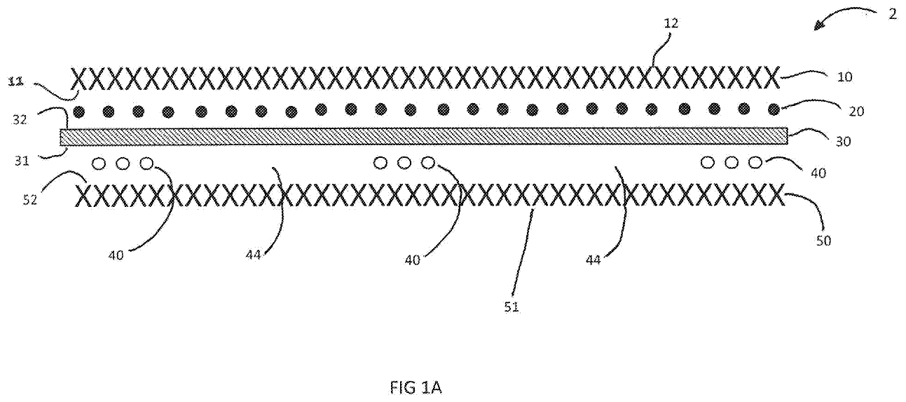

The present disclosure relates to a laminate structure providing thermal insulation and comprising a) an outer textile layer, b) a heat reactive material, c) a middle layer, wherein the middle layer is positioned on the heat reactive material opposite the outer textile layer such that the heat reactive material bonds the middle layer to the outer textile layer; d) a flame retardant adhesive material; and e) an inner layer, wherein the inner layer is positioned on the flame retardant adhesive material opposite the middle layer such that the flame retardant adhesive material bonds the inner layer to the middle layer. The flame retardant adhesive material is positioned in a pattern so as to form a plurality of pockets, each of the pockets defined by the middle layer, the inner layer and a portion of the flame retardant adhesive material. The pockets represent non-bonded areas wherein the middle layer and the inner layer are able to contact one another, but are separable from one another. Each of the pockets are formed by and bounded or surrounded by the flame retardant adhesive material, the middle layer and the inner layer. With reference to FIG. 1A, the laminate structure (2) includes a multilayer structure comprising an outer textile layer (10), a middle layer (30), an inner layer (50), a layer of a heat reactive material (20) sandwiched between and bonding together the outer textile layer (10) and the middle layer (30), and a patterned layer of a flame retardant adhesive material (40) sandwiched between and bonding together the middle layer (30) and the inner layer (50). The patterned layer of the flame retardant adhesive material (40) defines a pattern (42), a portion of which is shown in FIG. 1B, whereby a plurality of pockets (44) in non-bonded regions are formed between the middle layer (30) and the inner layer (50). The present disclosure also relates to a laminate structure providing thermal insulation wherein the laminate structure consists of a) an outer textile layer, b) a heat reactive material, c) a middle layer, wherein the middle layer is positioned on the heat reactive material opposite the outer textile layer such that the heat reactive material bonds the middle layer to the outer textile layer; d) a flame retardant adhesive material; and e) an inner layer, wherein the inner layer is positioned on the flame retardant adhesive material opposite the middle layer such that the flame retardant adhesive material bonds the inner layer to the middle layer. The present disclosure further relates to a laminate structure providing thermal insulation wherein the laminate structure consists essentially of comprising a) an outer textile layer, b) a heat reactive material, c) a middle flame retardant (FR) layer, wherein the middle layer is positioned on the heat reactive material opposite the outer textile layer such that the heat reactive material bonds the middle layer to the outer textile layer; d) a flame retardant adhesive material; and e) an inner layer, wherein the inner layer is positioned on the flame retardant adhesive material opposite the middle layer such that the flame retardant adhesive material bonds the inner layer to the middle layer. As used here, the phrase “consists essentially of” means that the laminate structure contains those elements listed and no other elements that would materially affect the performance of the laminate structure, for example, outer textile layers that might affect the ability of the laminate structure to resist melt dripping when exposed to an electrical arc or high temperature, or other elements that may increase the conduction of heat through the laminate structure and to a wearer of a garment made from the laminate structure.

Continuing to refer to FIG. 1A, the outer textile layer (10) has an inner side (11) and an outer side (12) and a heat reactive material (20) is provided on the inner side (11) of the outer textile layer (10). The middle layer (30) has an inner side (31) and an outer side (32), and the heat reactive material (20) is sandwiched between the inner side (11) of the outer textile layer (10) and the outer side (32) of the middle layer (30) and bonds the outer textile layer (10) to the middle layer (30). The middle layer (30) has an inner side (31) and an outer side (32) and the flame retardant adhesive material (40) is provided on the inner side (31) of the middle layer (30). The inner layer (50) has an inner side (51) and an outer side (52) and the flame retardant adhesive (40) is sandwiched between the inner side (31) of the middle layer (30) and the outer side (52) of the inner layer (50) and bonds the inner layer (50) to the middle layer (30).

The laminate structure comprises an outer textile layer (10). In some embodiments, the outer textile can comprise polyester fibers, polyamide fibers, polyolefin fibers, polyphenylene sulfide fibers or a combination thereof. Suitable polyesters can include, for example, polyethylene terephthalate, polytrimethylene terephthalate, polybutylene terephthalate or a combination thereof. Suitable polyamides, can include, for example, nylon 6, nylon, 6,6 or a combination thereof. Suitable polyolefins can include, for example, polyethylene, polypropylene or a combination thereof. In further embodiments, the outer textile layer (10) can be a meltable non-flammable textile such as, for example, a phosphinate modified polyester (such as materials sold under the trade name TREVIRA® CS by Trevira GmbH of Hattersheim Germany and under the trade name AVORA® FR by Rose Brand of Secaucus, N.J., USA). The outer textile layer (10) can be a knit, woven or a nonwoven. In some embodiments, the outer textile layer (10) is meltable. As used herein, a “meltable” material is a material that is meltable when tested according to the Melting and Thermal Stability test described hereinafter. In some embodiments, the outer textile layer (10) is flammable or non-flammable. As used herein, a “flammable” material is a material that is flammable when tested according to the Vertical Flame Test for Textiles described hereinafter to determine whether it is flammable or non-flammable.

Additionally, the outer textile layer can comprise relatively small quantities of flame retardant fibers, non-meltable fibers and/or antistatic fibers. If present, the flame retardant fibers, the non-meltable fibers and/or the antistatic fibers are present so that the outer textile is still a meltable textile when tested according to the Melting and Thermal Stability test described hereinafter. In some embodiments, the outer textile comprises a quantity of meltable fibers in a range of between 50 percent to 100 percent by weight of meltable fibers. In further embodiments, the meltable fibers are present in the outer textile layer in a range of from 75 percent to 100 percent by weight. In still further embodiments, the meltable fibers are present in the range of from 95 to 99 percent by weight and the remainder of the fibers are antistatic fibers in the range of from 1 to 5 percent by weight. All percentages by weight are based on the total weight of the outer textile layer.

In some embodiments, the outer textile layer (10) has a weight of less than or equal to about 250 grams per square meter (“gsm”). In some embodiments, the outer textile layer (10) has a weight of between 30 gsm and 250 gsm, or a weight of between 40 gsm and 200 gsm, or a weight of between 40 gsm and 175 gsm, or a weight of between 50 gsm and 175 gsm, or a weight of about 50 gsm, or a weight of between 50 gsm and 172 gsm, or a weight of about 76 gsm, or a weight of between 50 gsm and 170 gsm, or a weight of about 105 gsm, or a weight of between 100 gsm and 180 gsm, or a weight of about 172 gsm.

Meltable textiles are not typically used in arc resistant laminates as the standards governing the testing of arc resistant garments requires that the fabric or laminate be flame resistant in order to even qualify for arc testing (ASTM 1959). It is surprising that a laminate structure comprising an outer textile layer that is meltable can be used to provide protection against arc flash incidents.

The laminate structure further comprises a heat reactive material. In some embodiments, the heat reactive material (20) includes expandable graphite. In further embodiments, the heat reactive material (20) includes a mixture of expandable graphite and a polymer resin. The heat reactive material is positioned between the outer textile layer and the middle layer.

An expandable graphite most suitable for use in the embodiments disclosed herein has average expansion rate of at least 9 microns/° C. between about 180° C. and 280° C. Depending on the desired properties of the laminate structure, it may be desirable to use an expandable graphite having an expansion rate greater than 9 microns/° C. between about 180° C. and 280° C., or on expansion rate greater than 12 microns/° C. between about 180° C. and 280° C., or an expansion rate greater than 15 microns/° C. between about 180° C. and 280° C. One expandable graphite suitable for use in certain embodiments expands by at least 900 microns in TMA Expansion Test described herein when heated to about 280° C. Another expandable graphite suitable for use in certain embodiments expands by at least 400 microns in TMA Expansion Test described herein when heated to about 240° C. If tested using the Furnace Expansion Test described herein, expandable graphite suitable for use in heat reactive materials and methods described herein has an average expansion of at least 9 cubic centimeters per gram (cc/g) at 300° C. In one example, expandable graphite grade 3626 (available from Asbury Graphite Mills, Inc.) has an average expansion of about 19 cc/g at 300° C., whereas expandable graphite grade 3538 (available from Asbury Graphite Mills, Inc.) has an expansion of only about 4 cc/g at 300° C., when tested by the Furnace Expansion Test described herein. Expandable graphite particle size suitable for present invention should be chosen so that the heat reactive material may be applied with the selected application method. For example, where the heat reactive material is applied by a gravure printing technique, the expandable graphite particle size should be small enough to fit in the gravure cells.

In some embodiments, heat reactive materials are formed comprising expandable graphite having the above described expansion and an endotherm of at least about 100 Joules per gram (J/g) when tested according to the DSC Endotherm Test method described herein. In other embodiments, it may be desirable to use expandable graphite with endotherm greater than or equal to about 150 J/g, greater than or equal to about 200 J/g, or an endotherm greater than or equal to about 250 J/g.

Polymer resins that are suitable for the heat reactive material can have a melt or softening temperature of less than 280° C. In some embodiments, polymer resins used are sufficiently flowable or deformable to allow the expandable graphite to expand substantially upon heat exposure at or below 300° C. In some embodiments, polymer resins used are sufficiently flowable or deformable to allow the expandable graphite to expand substantially upon heat exposure at or below 280° C. In some embodiments, other polymer resins suitable for use in the heat reactive material allow the expandable graphite to sufficiently expand at temperatures below the pyrolysis temperature of the meltable outer textile. In some embodiments, the extensional viscosity of a polymer resin is low enough to allow for the expansion of expandable graphite and high enough to maintain the structural integrity of the heat reactive material after expansion of the mixture of polymer resin and expandable graphite. In some embodiments, a polymer resin is used which has a storage modulus between 10³ and 10⁸ dyne/cm² and Tan delta between about 0.1 and about 10 at 200° C. In another embodiment a polymer resin is used that has a storage modulus between 10³ and 10⁶ dyne/cm². In another embodiment a polymer resin is used that has a storage modulus between 10³ and 10⁴ dyne/cm². Polymer resins suitable for use in some embodiments have a modulus and elongation at around 300° C. or less, suitable to allow the expandable graphite to expand. Polymer resins suitable for use in some embodiments are elastomeric. Other polymer resins suitable for use in some embodiments are cross-linkable, such as crosslinkable polyurethane available as MOR-MELT™ adhesive R7001 E (from Rohm & Haas). In other embodiments, suitable polymer resins are thermoplastic having a melt temperature between 50° C. and 250° C., such as DESMOMELT® adhesive VP KA 8702 (from Bayer Material Science LLC). Polymer resins suitable for use in embodiments described herein comprise polymers which include but are not limited to polyesters, polyether, polyurethane, polyamide, acrylic, vinyl polymer, polyolefin, silicone, epoxy or a combination thereof.

Flame retardant materials may be incorporated in the heat reactive material or the polymer resin, such as melamine, phosphorous, metal hydroxides such as alumina trihydrate (ATH), borates, or a combination thereof. Other flame retardant materials can include, for example, brominated compounds, chlorinated compounds, antimony oxide, organic phosphorous-based compounds, zinc borate, ammonium polyphosphate, melamine cyanurate, melamine polyphosphate, molybdenum compounds, magnesium hydroxide, triphenyl phosphate, resorcinol bis-(diphenylphosphate), bisphenol-A-(diphenylphosphate), tricresyl phosphate, organophosphinates, phosphonate esters or a combination thereof. If present, the flame retardant materials can be used in a proportion of from 1 percent to 50 percent by weight, based on the total weight of the polymer resin.

In some embodiments of the heat reactive material, the heat reactive material is a mixture, and, upon exposure to the heat from an electrical arc, forms a plurality of tendrils comprising expanded graphite. The total surface area of the heat reactive material increases significantly when compared to the same mixture prior to expansion. In one embodiment, the surface area of the mixture is increased at least five times after expansion. In another embodiment, the surface area of the mixture is increased at least ten times after expansion. In addition, tendrils will often extend outward from the expanded mixture. In one embodiment where the heat reactive material is situated on the outer textile layer or the middle layer in a discontinuous form, the tendrils can extend to at least partially fill the open areas between the discontinuous domains. In a further embodiment, the tendrils will be elongated, having a length to width aspect ratio of at least 5 to 1. In one embodiment, wherein the heat reactive material comprising a polymer resin-expandable graphite mixture is applied in a pattern of discontinuous forms, the heat reactive material expands forming tendrils that are loosely packed after expansion creating voids between the tendrils, as well as space between the pattern of the heat reactive material. Upon exposure to the heat from an electric arc, the meltable outer textile melts and generally moves away from the open areas between the discontinuous forms of the heat reactive material.

The middle layer can provide support to the heat reactive material during expansion and the melt of the meltable outer textile is absorbed and retained by the expanding heat reactive material during melting. By absorbing and retaining the melt, laminates can be formed that exhibit no melt-dripping and flammability is suppressed. It is believed that the middle layer supports the expanding heat reactive material during melt absorption, thereby preventing the laminate structure from breaking open and preventing or minimizing the formation of holes. The increased surface area of the heat reactive material upon expansion allows for absorption of the melt from the meltable textile by the expanded heat reactive material upon exposure to heat from an electric arc.

In some embodiments, the heat reactive material is produced by a method that provides an intimate blend of polymer resin and expandable graphite, without causing substantial expansion of the expandable graphite. In some embodiments, the polymer resin and an expandable graphite having an endotherm of at least 100 J/g, can be blended to form a mixture that can be applied in a continuous or a discontinuous pattern to either the outer textile layer or the middle layer or both. Suitable mixing methods include but not limited to paddle mixer, blending and other low shear mixing techniques. In one method, the intimate blend of polymer resin and expandable graphite particles is achieved by mixing the expandable graphite with a monomer or prepolymer prior to polymerization of the polymer resin. In another method, the expandable graphite may be blended with a dissolved polymer, wherein the solvent is removed after mixing or after application to the outer textile layer, the middle layer or both. In another method, expandable graphite is blended with a hot melt polymer at a temperature below the expansion temperature of the graphite and above the melting temperature of the polymer. In methods which provide an intimate blend of polymer resin and expandable graphite particles or agglomerates of expandable graphite, the expandable graphite is coated or encapsulated by the polymer resin prior to expansion of the graphite. In some embodiments, the intimate blend is achieved prior to applying the heat reactive material to the outer textile layer or the middle layer.

In some embodiments, the heat reactive material comprises less than or equal to about 50 wt %, or less than or equal to about 40 wt %, or less than or equal to about 30 wt % expandable graphite based on the total weight of the heat reactive material, and the balance substantially comprising the polymer resin. In other embodiments, the expandable graphite comprises less than or equal to about 20 wt %, or less than or equal to about 10 wt %, or less than or equal to about 5 wt % of the mixture, and the balance substantially comprising the polymer resin. Generally, from about 5 wt % to 50 wt % of expandable graphite based on the total weight of the heat reactive material, is desired. In some embodiments, desirable flame resistance performance may be achieved with even lower amounts of expandable graphite. In some embodiments, loadings as low as 1% may be useful. Depending on the properties desired and the construction of the resulting laminate structures, other levels of expandable graphite may also be suitable for other embodiments. Other additives such as pigments, fillers, antimicrobials, processing aids and stabilizers may also be added to the heat reactive material.

The heat reactive material can be applied to one or both of the inner surface (11) of the outer textile layer (10) or the outer surface (32) of the middle layer (30) such as exemplified in FIG. 1C. In some embodiments, the heat reactive material may be applied as a continuous layer. In some embodiments, where enhanced breathability and/or hand is desired, the heat reactive material may be applied discontinuously to form a layer of heat reactive material having less than 100% surface coverage. As shown in FIG. 1C, the heat reactive material (20) can be applied in a dot pattern. A discontinuous application of the heat reactive material may provide less than 100% surface coverage by forms including but not limited to dots, grids, lines, and combinations thereof. In some embodiments with discontinuous coverage, the average distance between adjacent areas of the discontinuous pattern of the heat reactive material is less than the size of an impinging flame. In some embodiment with discontinuous coverage, the average distance between adjacent areas of the discontinuous pattern is less than 10 millimeters (mm), or less than 5 mm, or less than 3.5 mm, or 2.5 mm or less, or 1.5 mm or less, or 0.5 mm or less. For example, in a dot pattern printed of the heat reactive material onto the outer textile layer or the middle layer, the spacing between the edges of two adjacent dots of heat reactive material would be measured. An average distance between adjacent areas of the discontinuous pattern may be greater than 40 microns, or greater than 50 microns, or greater than 100 microns, or greater than 200 microns, depending on the application. Average dot spacing measured to be greater than 200 microns and less than 500 microns is useful in some laminates described herein.

In some embodiments, pitch is used, for example, in combination with surface coverage as a way to describe the laydown of a printed pattern. In general, pitch is defined as the average center-to-center distances between adjacent forms such as dots, lines, or gridlines of the printed pattern. The average is used, for example, to account for irregularly spaced printed patterns. In some embodiments, the heat reactive material (20) can be applied discontinuously in a pattern with a pitch and surface coverage that provides superior flame retardant performance compared to a continuous application of heat reactive mixture having a laydown of equivalent weight of the heat reactive material. In some embodiments of irregular patterns, the pitch is defined as the average of the center-to-center distances between adjacent dots or grid lines. In some embodiments, the pitch is greater than 500 microns, or greater than 1000 microns, or greater than 2000 microns, or greater than 5000 microns. A pattern of heat reactive material having a pitch between 500 microns and 6000 microns is suitable for use in most laminates described herein. In embodiments where properties such as hand, breathability, and/or textile weight are important, a surface coverage of greater than about 25%, and less than about 90%, or less than about 80%, or less than about 70%, or less than about 60%, or less than about 50%, or less than about 40%, or less than about 30% may be used. In certain embodiments where, for example, greater flame resistant properties are needed, it may be desired to have a surface coverage between about 30% and 80% of the heat reactive material on a surface of the outer textile layer or middle layer with pitch between 500 microns and 6000 microns.

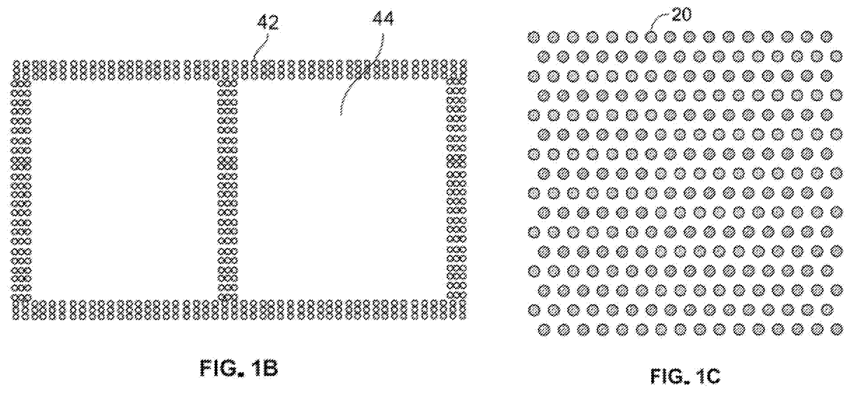

In some embodiments, a method for achieving a coverage of less than 100% comprises applying the heat reactive material by printing onto a surface of the outer textile or the middle layer by, for example gravure printing. FIGS. 2A and 2B illustrate examples in which the layer of heat reactive material (20) is provided in patterns of dots (2A) and grids (2B) for example to a outer textile layer (10) such as the outer side (32) of the middle layer (30) or to the inner side (11) of an outer textile layer (10). In some embodiments, the heat reactive material is applied to achieve an add-on weight of between about 10 gsm to about 100 gsm of the heat reactive material. In some embodiments, the heat reactive material is applied to the outer textile layer or the middle layer to achieve an add-on weight of less than 100 gsm, or less than 75 gsm, or less than 50 gsm, or less than 25 gsm.

In some embodiments, such as in the application of discrete dots (20) in FIG. 2A, the heat reactive material is applied to a outer textile layer (10) forming a layer of heat reactive material (20) in the form of a multiplicity of discrete pre-expansion structures comprising the heat reactive material. Upon expansion, the discrete dots form a multiplicity of discrete expanded structures having structural integrity thereby providing sufficient protection to a laminate structure to achieve the enhanced properties described herein. By structural integrity it is meant that the heat reactive material after expansion withstands flexing or bending without substantially disintegrating or flaking off the outer textile layer or the middle layer or both.

In some embodiments, the heat reactive material may be applied in other forms in addition to dots, lines, or grids. Other methods for applying the heat reactive material may include screen printing, or spray or scatter coating or knife coating, provided the heat reactive material may be applied in a manner in which the desired properties upon exposure to the heat from an electrical arc are achieved.

In some embodiments, the layer of heat reactive material (20) may be disposed on the outer textile layer (10) or on the middle layer (30) in a manner in which the heat reactive material provides a good bond between the middle layer (30) and the outer textile layer (10). The heat reactive material functions as an adhesive, for example, to bond the inner side (11) of the outer textile layer (10) and the outer side (32) of the middle layer (30) forming a layer of heat reactive material between the outer textile layer (10) and the middle layer (30). During the formation of the laminate structure, the heat reactive material is applied in a continuous or discontinuous manner to the outer textile or to the middle layer, the outer textile layer and the middle layers are then adhered to one another, generally by running through the nip of two rollers. The pressure from the nip can cause at least the polymer resin of the heat reactive material to be disposed at least partially within surface pores, surface voids or voids or spaces between the fibers of one or both of the layers (10 and 30). In some embodiments, at least the polymer resin of the heat reactive layer can penetrate the voids or spaces between the fibers and/or filaments of the outer textile layer. In other embodiments, at least the polymer resin of the heat reactive material can penetrate into the middle layer. In still further embodiments, at least the polymer resin of the heat reactive material can penetrate the voids or spaces between the fibers of the outer textile material and can penetrate into the middle layer.

The laminate structure also includes a middle layer. The middle layer comprises a barrier layer, for example, a polyimide, a silicone or a polytetrafluroethylene (PTFE) layer. In some embodiments, the middle layer can be an expanded polytetrafluoroethylene (ePTFE). In still further embodiments, the middle layer is a 2-layer film that comprises (a) a first layer of expanded polytetrafluoroethylene and (b) a second layer of expanded polytetrafluoroethylene; or a polyurethane coated expanded polytetrafluoroethylene. The middle layer can be an FR textile layer, however, if a textile layer is used as the middle layer, the textile layer should contain a relatively high density of warp and weft fibers or filaments which can increase the weight and stiffness of the laminate structure. The middle layer can be a film having a thickness of less than 1 millimeter (mm) and a hand less than 100, when measured by the Flexibility or Hand Measurement Test described herein, to achieve a particular thinness and hand of the resulting laminate structure (2). Suitable films can comprise materials such as a heat stable film, and include materials such as polyimide, silicone, PTFE, such as PTFE or expanded PTFE. In some embodiments, the middle layer can prevent or minimize the heat transfer from the electrical arc to the layers behind it. In addition, in some embodiments, the middle layer can facilitate melt absorption. Materials not suitable as the middle layer include films lacking sufficient thermal stability, such as many breathable polyurethane films and breathable polyester films (such as SYMPATEX® films, particularly thermoplastics). In some embodiments, films for use in embodiments described herein have a maximum air permeability of less than about 25 l/m²/sec after thermal exposure when tested as per the Barrier Thermal Stability Test method described herein. In some embodiments, a film has an air permeability after an electrical arc exposure sufficient to expand the expandable graphite of less than 3 Frazier.

In some embodiments, the middle layer (30) has a weight in the range of between 10 gsm and 50 gsm, or in the range of between 20 gsm and 50 gsm, or in the range of between 30 gsm and 50 gsm, or in the range of between 40 gsm and 50 gsm, or in the range of between 10 gsm and 40 gsm, or in the range of between 20 gsm and 40 gsm, or in the range of between 30 gsm and 40 gsm, or in the range of between 10 gsm and 30 gsm, or in the range of between 20 gsm and 30 gsm, or in the range of between 15 gsm and 35 gsm, or in the range of between 20 gsm and 35 gsm, or in the range of between 25 gsm and 35 gsm, or in the range of between 30 gsm and 35 gsm, or in the range of between 15 gsm and 30 gsm, or in the range of between 25 gsm and 30 gsm, or in the range of between 15 gsm and 25 gsm, or in the range of between 20 gsm and 25 gsm, or in the range of between 15 gsm and 20 gsm, or in the range of between 21 gsm and 23 gsm, or in the range of between 29 gsm and 31 gsm, or about 22 gsm, or about 30 gsm.

In some embodiments, the middle layer is a thermally stable barrier layer. A thermally stable barrier layer can help to prevent the heat transfer from the outer side of the laminate structure to the inner side of the laminate structure during exposure to an electrical arc. Thermally stable barriers for use as the middle layer in the embodiments described herein, have a maximum air permeability of 50 l/m²/sec after thermal exposure when tested according to the air permeability test for thermally stable barriers as disclosed herein. In other embodiments, the middle layers have a maximum air permeability of less than 25 l/m²/sec or less than 15 l/m²/sec, after thermal exposure.

The laminate structure further comprises a flame retardant adhesive (40), wherein the flame retardant adhesive (40) is sandwiched between the middle layer and the inner layer. Any of the polymer resins described as being useful for the heat reactive material can be used for the flame retardant adhesive, provided that a sufficient amount of flame retardant additive is present. The flame retardant adhesive (40) typically comprises one or more polymer resins and one or more flame retardant additives. In some embodiments, the flame retardant adhesive (40) consists of or consists essentially of one or more polymer resins and one or more flame retardant additives. As used herein, “consists essentially of” means that the composition contains those components listed and less than 5 percent by weight of any additional component that might materially affect the composition. In other embodiments, the composition contains less than 4 percent or less than 3 percent or less than 2 percent or less than 1 percent of any additional component. Suitable polymer resins can include, for example, polyesters, polyether, polyurethane, polyamide, acrylic, vinyl polymer, polyolefin, silicone, epoxy or a combination thereof. In some embodiments, the polymer resins can be thermoplastic, while in other embodiments, the polymer resins can be crosslinkable. Polymer resins suitable for use in some embodiments can include, for example, crosslinkable polyurethane such as that sold under the trade name MOR-MELT™ R7001 E by Rohm & Haas of Philadelphia, Pa., USA. In other embodiments, suitable polymer resins are thermoplastic having a melt temperature between 50° C. and 250° C., such as that sold under the trade name DESMOMELT® VP KA 8702, sold by Bayer MaterialScience LLC of Pittsburgh, Pa., USA. In some embodiments, flame retardant properties of the flame retardant adhesive material (40) are provided by the incorporation of flame retardant materials in the polymer resin. Flame retardant materials can include, for example, one or more of brominated compounds, chlorinated compounds, antimony oxide, organic phosphorous-based compounds, zinc borate, ammonium polyphosphate, melamine cyanurate, melamine polyphosphate, molybdenum compounds, magnesium hydroxide, triphenyl phosphate, resorcinol bis-(diphenylphosphate), bisphenol-A-(diphenylphosphate), tricresyl phosphate, organophosphinates, phosphonate esters or a combination thereof. In some embodiments, the flame retardant materials can be used in a proportion of from 1 percent to 50 percent by weight, based on the total weight of the polymer resin.

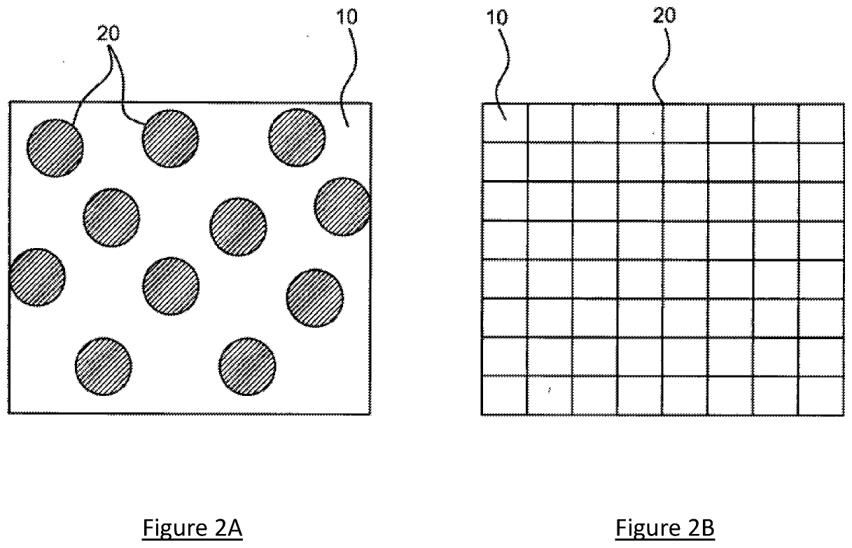

The flame retardant adhesive material (40) bonds the middle layer and the inner layer and is applied discontinuously to form a layer of flame retardant adhesive material (40). The flame retardant adhesive material (40) is applied in a pattern (42) having less than 100% surface coverage across the surface of the middle layer and the inner layer. FIGS. 3B and 3C show potential grid-like patterns (42) of flame retardant adhesive material that defines a plurality of pockets (44). The pockets (44) represent regions where the middle layer and the inner layer are not bonded to each other. The pockets are further defined by the flame retardant adhesive (40) surrounding each pocket. The flame retardant adhesive material bonds the middle layer and the inner layer in those areas defined by the pattern (42) of flame retardant adhesive, while the pockets (44) define non-bonded regions where the middle layer and the inner layer are not bonded to each other. The pockets themselves are free from the flame retardant adhesive material or the pockets are essentially free from the flame retardant adhesive material. As used here, the phrase “essentially free from” means that the non-bonded region contains less than 5 percent or less than 4 percent or less than 3 percent or less than 2 percent or less than 1 percent of the flame retardant adhesive, when measuring the area of the pocket. In some embodiments, a relatively weak adhesive composition may ‘temporarily’ adhere the middle layer and the inner layer so that the middle and inner layers do not separate under ordinary use. However, during exposure to an electrical arc, the energy from the electrical arc should be sufficient to melt or degrade the weak adhesive composition in the pocket region thereby allowing the separation of the middle layer and the inner layer and the expansion of the pocket as described herein.

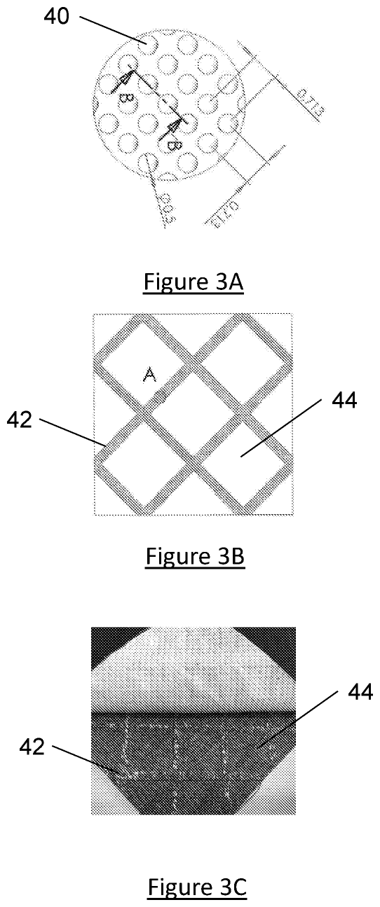

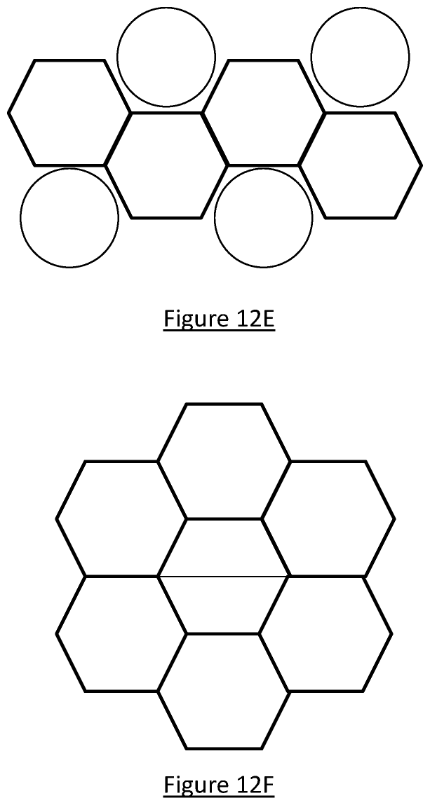

The flame retardant adhesive material (40) can be positioned in a pattern so as to form the pockets (44). The pattern (42) can be applied as solid lines of the flame retardant adhesive material or the pattern can be lines that comprise a series of closely spaced dots of the flame retardant adhesive material, as shown in FIGS. 3A and 3B. While the term “dots” is used to describe the shape of the applied flame retardant adhesive, the flame retardant adhesive can be applied using any regular or irregular shape, for example, dots, squares, pentagons, hexagons, lines, regular or irregular shapes. FIG. 3A shows one specific embodiment wherein the flame retardant adhesive can be applied as a series of dots each having a diameter of 0.5 millimeters (mm) and a center to center spacing (pitch) between adjacent dots of 0.713 mm. The flame retardant adhesive can be positioned, or applied, in a pattern. The pattern can be any regularly repeating pattern that defines the pocket. As shown in FIG. 3B, the pattern is a grid pattern forming rectangular/square pockets. As shown in FIG. 3D, the pattern is a series of sinusoidal lines wherein the sinusoidal waves travel in a first direction (e.g., as shown by the arrow labeled “direction of travel” in FIG. 3D), are spaced from one another in a second direction that is perpendicular to the first direction (e.g., as shown by the arrow labeled “direction of spacing” in FIG. 3D), and are offset from one another along the first direction to an extent such that the peak of one of the sinusoidal waves is aligned with the trough of an adjacent sinusoidal wave. In some embodiments, the peaks and troughs touch. In some embodiments, the peaks and troughs overlap. In some embodiments, the sinusoidal waves define a bonded area or pattern (42) and a non-bonded area or pocket (44) as described above with reference to FIG. 3B. In still further embodiments, other regularly repeating patterns can be used. For example, a pattern (42) of circles, of rectangles, of pentagons, of hexagons, of polygons could be used, for example, as shown. In further embodiments, a pattern (42) may include a combination of different polygons or shapes, as depicted in FIG. 12E. Adjacent polygons or shapes can share a common (adjacent) edge, for example, as shown in FIGS. 12A, 12C and 12E or can have edges independent of one another, for example, as shown in FIGS. 12B, 12D and 12F. If the polygons or other shapes are independent from one another and there is a non-bonded region in between adjacent edges, care should be taken that the distance between adjacent edges is kept relatively small, for example, less than or equal to 5 mm, or less than 4 mm, or less than 3 mm, or less than 2 mm, or less than 1 mm. In some embodiments, regularly repeating polygons each share a common side with the adjacent polygon as shown in FIG. 12A. In still further embodiments, the pattern can have relatively small openings. In a specific example, a circular pattern can have a relatively small opening, so that the pattern of the flame retardant adhesive resembles the letter “C”. However, the opening should be kept as small as possible. In other embodiments, the pattern is a continuous pattern with no openings, for example, the pattern shown in FIG. 4B.

In some embodiments, digital printing may be used to produce a randomized pattern (not shown) of the flame retardant adhesive material (40). The randomized pattern may comprise any combination of shapes and/or polygons.

The pockets (44), which represent unbonded areas between the middle layer and the inner layer, can have an area that is in the range of from a minimum of 25 millimeters² (mm²) to a maximum of 22,500 mm². The area of a pocket refers to the average area of the individual pockets of the laminate structure. If the laminate structure includes pockets of different shapes and/or sizes, then at least 80% of the pockets should have an area that is in the range of from 25 mm² to 22,500 mm². In embodiments such as shown in FIG. 12B, where the pattern is made of shapes having no common edges, only the areas of the pockets are used to calculate the pocket area; and as the distance between adjacent edges gets larger, this can require that the area of the pockets be larger. For example, if a regular repeating pattern of square pockets having an area of 50 mm² is used, then the distance between the edges of adjacent square pockets should be as small as possible, for example, less than 2 mm or less than 1 mm. In other embodiments, the pockets can have an area in the range of from 25 mm² to 22,000 mm² or from 30 mm² to 22,000 mm² or from 35 mm² to 22,0000 mm² or from 40 mm² to 22,000 mm² or from 45 mm² to 22,000 mm² or 50 mm² to 22,000 mm² or from 75 mm² to 22,000 mm² or from 100 mm² to 22,000 mm² or from 100 mm² to 20,000 mm² or from 100 mm² to 15,000 mm² or from 100 mm² to 10,000 mm² or from 100 mm² to 9,000 mm² or from 100 mm² to 8,000 mm² or from 100 mm² to 7,000 mm² or from 100 mm² to 6,000 mm² or from 100 mm² to 5,000 mm² or from 100 mm² to 4,000 mm² or from 100 mm² to 3,000 mm² or from 100 mm² to 2,000 mm² or from 100 mm² to 1,000 mm² or from 100 mm² to 900 mm² or from 100 mm² to 800 mm² or from 100 mm² to 700 mm² or from 100 mm² to 600 mm² or from 100 mm² to 500 mm² or from 100 mm² to 400 mm².

The flame retardant adhesive can be applied using known lamination techniques that can be used to produce the desired pattern, for example, gravure printing, screen printing or ink jet printing. In some embodiments, the flame retardant adhesive material is positioned (or applied) so as to form a plurality of pockets, each of the pockets defined by (a) the middle layer, (b) the inner layer and (c) a portion of the flame retardant adhesive material, and wherein the pattern of the flame retardant adhesive material covers less than 75% of the outer surface of the inner layer. In some embodiments, the pattern of the flame retardant adhesive material comprises a grid pattern including a first series of parallel lines oriented in a first direction and a second series of parallel lines oriented in a second direction, the first direction and the second direction being offset from one another at an angle that is in the range of between 30 degrees and 90 degrees. In one embodiment, the flame retardant adhesive can be applied using a gravure roll, wherein the gravure roll has a grid-like pattern having a first series of parallel lines and a second series of parallel lines that are oriented 90 degrees relative to the first series of parallel lines. For example, each line can be formed from individual dots, the dots having a dot size of 0.5 millimeters (mm), the dots having a center-to-center distance (pitch) of 0.713 mm, the lines being 3.4 mm wide and two adjacent parallel lines having a center-to-center distance of 23.53 mm. The pockets defined by the lines is the flame retardant adhesive material can be, for example, about 404 square millimeters

The laminate structure further comprises an inner layer (50). The inner layer (50) may be an inner textile layer which may be produced from any known textile fiber or filament. The textile can comprise flame retardant fibers, non-flame retardant fibers, synthetic fibers, natural fibers or a combination thereof. The textiles can be woven, knit or nonwoven textiles. In some embodiments, the knit can be a circular knit, a flat knit, a warp knit or a Raschel knit. Examples of suitable flame retardant textiles include textiles produced from p-aramid, m-aramid, polybenzimidazole, polybenzoxazole, polyetheretherketone, polyetherketoneketone, polyphenyl sulfide, polyimide, melamine, fluoropolymer, polytetrafluoroethylene, modacrylic, cellulose, polyvinylacetate, mineral, protein fibers, or a combination thereof. Other textiles that are not flame retardant can also be used, for example, textiles that comprise synthetic fibers, natural fibers or textiles that comprise both synthetic and natural fibers. Suitable synthetic textiles can include, for example, polyesters, polyamides, polyolefins, acrylics, polyurethanes or a combination thereof. Suitable natural fibers can include, for example, cotton, wool, cellulose, animal hair, jute, hemp or any other naturally occurring fiber. Combinations thereof may also be used. In some embodiments, a small proportion, for example, less than 10 percent by weight of antistatic fibers or filaments can be added to the textile, wherein the percentage by weight is based on the total weight of the textile. Suitable antistatic fibers/filaments are known in the art and can include, for example, conductive metals, copper, nickel, stainless steel, steel, gold, silver, titanium, carbon fibers. In still further embodiments, the inner textile layer can comprise a small percentage of elastic filaments. Suitable elastic filaments can include, for example, polurethane, elastane, spandex, silicone, rubber or a combination thereof.

In some embodiments, the inner layer (50) comprises a woven, a knit or a nonwoven textile having a weight in the range of from 15 gsm to 450 gsm. In other embodiments, the inner layer comprises a weight in the range of from 20 gsm to 450 gsm or 25 gsm to 450 gsm or 15 gsm to 400 gsm or 20 gsm to 400 gsm or 25 gsm to 400 gsm or 15 gsm to 375 gsm or 20 gsm to 375 gsm or 25 gsm to 375 gsm or 15 gsm to 350 gsm or 20 gsm to 350 gsm or 25 gsm to 350 gsm or 15 gsm to 325 gsm or 20 gsm to 325 gsm or 25 gsm to 325 gsm or 15 gsm to 300 gsm or 20 gsm to 300 gsm or 25 gsm to 300 gsm or 15 gsm to 275 gsm or 20 gsm to 275 gsm or 25 gsm to 275 gsm or 15 gsm to 250 gsm or 20 gsm to 250 gsm or 25 gsm to 250 gsm or 15 gsm to 225 gsm or 20 gsm to 225 gsm or 25 gsm to 225 gsm or 15 gsm to 200 gsm or 20 gsm to 200 gsm or 25 gsm to 200 gsm or 30 gsm to 250 gsm or of 40 gsm to 250 gsm or of 50 gsm to 250 gsm or of 50 gsm to 200 gsm or 50 gsm to 190 gsm or 50 gsm to 180 gsm or 50 gsm to 170 gsm or 50 gsm to 160 gsm or 50 gsm to 150 gsm or 50 gsm to 140 gsm or 50 gsm to 130 gsm or 50 gsm to 120 gsm or 50 gsm to 110 gsm or 50 gsm to 100 gsm or 50 gsm to 90 gsm. The inner layer can be a textile layer wherein the textile layer comprises a flame retardant textile, a meltable textile or is a textile comprising both flame retardant and meltable fibers. In some embodiments, the inner layer is a woven textile that is produced from an aramid and a flame retardant viscose. In some embodiments, the inner layer (50) comprises a woven aramid and flame retardant viscose textile including 50% aramid and 50% viscose. In some embodiments, the inner layer (50) comprises a woven aramid and flame retardant viscose textile having a weight of about 50 gsm to 250 gsm. In some embodiments, the inner layer (50) comprises a polyethylene terephthalate (“PET”) interlock textile. In some embodiments, the inner layer (50) comprises a PET knit textile having a weight of about 50 gsm to 200 gsm. In some embodiments, the inner layer (50) comprises a modacrylic/cotton blend (MAC/CO) knit textile. In some embodiments, the inner layer (50) comprises a MAC/CO knit textile having a weight of about 50 gsm to 200 gsm. In some embodiments, the inner layer (50) comprises a PET knit textile having a weight of about 50 gsm to 200 gsm. In some embodiments, the inner layer (50) comprises a modacrylic/cotton blend (MAC/CO) knit textile. In some embodiments, the inner layer (50) comprises a MAC/CO knit textile having a weight of about 100 gsm to 200 gsm. In some embodiments, the inner layer (50) comprises a MAC/CO knit textile further comprising 5 percent or less of antistatic fibers and having a weight of about 100 gsm to 200 gsm. In some embodiments, the inner layer (50) is a modacrylic knit. In some embodiments, the inner layer (50) is a modacrylic knit having a weight of about 50 gsm to 200 gsm.

In some embodiments, the laminate structure (2) as disclosed above can have a weight of less than or equal to 500 gsm. In other embodiments, the weight of the laminate structure can be less than 400 gsm or less than 375 gsm or less than 350 or less than 325 gsm or less than 300 gsm or less than 275 gsm.

In some embodiments, the laminate structure (2) can provide a user with protection from exposure to an electric arc, also called “arc flash protection”. In some embodiments, the laminate structure (2) provides arc flash protection satisfying the EN standards EN 61482-1-1:2014 and/or EN 61482-1-2:2014 in both panel form and in garment form. In some embodiments, the laminate structure (2) provides class 2 arc flash protection and satisfies the EN standard EN 61482-1-2:2014. In some embodiments, to satisfy the EN standard EN 61482-1-2:2014, the laminate structure that is exposed to an arc flash as defined in the EN standard EN 61482-1-2:2014 while in panel form can provide one or more of the following criteria, have a plot of transmitted incident energy against time that is less than the standard known as the Stoll Curve; an afterflame time that is less than or equal to 5 seconds; or the size of any holes formed must be less than or equal to 5 millimeters. In other embodiments, an article comprising the laminate structure that is exposed to an arc flash as defined in the EN standard EN 61482-1-2:2014 while in panel form can provide an article that can have one or more of the following criteria, an afterflame time that is less than or equal to 5 seconds; the size of any holes formed must be less than or equal to 5 millimeters; or the article must display no melting or dripping; or the front zipper of the garment must open easily.

In some embodiments, it is believed that when a laminate structure (2) as described above is exposed to an electrical arc, such as that applied in accordance with the standards EN 61482-1-1:2014 and/or EN 61482-1-2:2014, portions of the laminate structure (2) expand and bow away from one another. In some embodiments, upon exposure to an electrical arc, the outer textile layer (10) melts and the heat reactive material (20) expands. As the heat reactive material expands, the expanding heat reactive material absorbs the melted or melting outer textile layer thereby preventing the outer textile layer from sustaining a flame and also preventing the outer textile layer from dripping. In some embodiments, upon exposure to an electrical arc, the layer of heat reactive material (20) expands due to the presence of expandable graphite. Upon exposure to an electrical arc, the pockets defined by the middle layer, the inner layer and the flame retardant adhesive material expand so that the middle layer and the inner layer separate from each other, thereby forming air gaps. The separation of the pockets defined by the middle layer and the inner layer can be seen by the difference in the appearance of the laminate structure in FIG. 4A (before exposure to an electrical arc) and 4B (after exposure to an electrical arc).

FIG. 4A shows the inner layer of an exemplary laminate structure (2) before the application of an arc flash, while FIG. 4B shows the inner layer of the laminate structure (2) after the application of an arc flash. As can be seen, the laminate structure (2), which includes a bonded area (42) as shown in FIG. 4B, includes expanded regions (46) overlaying the pockets (44). In some embodiments, the expanded regions (46) form air gaps within the laminate structure (2), thereby providing improved insulation and improving the performance of the laminate structure (2) in testing such as testing against the Stoll Curve as described above. In some embodiments, the insulation provided by the expanded regions (46) enables the laminate structure (2) to comply with the standards EN 61482-1-1:2014 and/or EN 61482-1-2:2014 while including layers of material of lighter weight than laminate structures including the same or similar materials but lacking a pattern including the bonded area (42) and the pocket (44) that are operative to produce the expanded regions (46) as described above.

In some embodiments, the laminate structure (2) complies with the standards EN 61482-1-1:2014 and/or EN 61482-1-2:2014 and has a weight of less than or equal to 500 gsm. In some embodiments, the laminate structure (2) complies with the standards EN 61482-1-1:2014 and/or EN 61482-1-2:2014 and has a weight of less than or equal to 475 gsm. In some embodiments, the laminate structure (2) complies with the standards EN 61482-1-1:2014 and/or EN 61482-1-2:2014 and has a weight of less than or equal to 450 gsm. In some embodiments, the laminate structure (2) complies with the standards EN 61482-1-1:2014 and/or EN 61482-1-2:2014 and has a weight of less than or equal to 425 gsm. In some embodiments, the laminate structure (2) complies with the standards EN 61482-1-1:2014 and/or EN 61482-1-2:2014 and has a weight of less than or equal to 400 gsm. In some embodiments, the laminate structure (2) complies with the standards EN 61482-1-1:2014 and/or EN 61482-1-2:2014 and has a weight of less than or equal to 375 gsm. In some embodiments, the laminate structure (2) complies with the standards EN 61482-1-1:2014 and/or EN 61482-1-2:2014 and has a weight of less than or equal to 350 gsm. In some embodiments, the laminate structure (2) complies with the standards EN 61482-1-1:2014 and/or EN 61482-1-2:2014 and has a weight of less than or equal to 325 gsm. In some embodiments, the laminate structure (2) complies with the standards EN 61482-1-1:2014 and/or EN 61482-1-2:2014 and has a weight of less than or equal to 300 gsm. In some embodiments, the laminate structure (2) complies with the standards EN 61482-1-1:2014 and/or EN 61482-1-2:2014 and has a weight of less than or equal to 275 gsm. In some embodiments, the laminate structure (2) complies with the standards EN 61482-1-1:2014 and/or EN 61482-1-2:2014 and has a weight of less than or equal to 265 gsm.

The disclosed laminate structure also can resist shrinkage upon exposure to an electrical arc. In some embodiments, the laminate structure shrinks less than 10% when tested according to a thermal shrinkage test, disclosed hereinafter. In still further embodiments, the laminate structure shrinks less than 5% or less than 4% or less than 3% or less than 2% upon exposure to an electrical arc. In some embodiments, laminate structures made according to the methods described herein have a moisture vapor transmission rate (“MVTR”) greater than about 1000, or greater than about 3000, or greater than about 5000, or greater than about 7000, or greater than about 9000, or greater than about 10000, or higher, as tested in accordance with the MVTR test described below. In some embodiments, laminate structures have a break open time greater than about 50 seconds, greater than about 60 seconds, or even greater than 120 seconds when tested according to the methods for Horizontal Flame Test described herein. In some embodiments, laminate structures also have an afterflame less than 20 seconds when tested according to the Horizontal Flame Test described herein. In some embodiments, laminate structures have an afterflame less than 15 seconds, or less than 10 seconds, or less than 5 seconds, when tested by the Horizontal Flame Test. In some embodiments, laminate structures exhibit substantially no melt dripping behavior when tested in the Horizontal Flame test.

The laminate structure (2) can be used as a garment, wherein the garment is configured such that the inner layer faces a wearer when the garment is worn by the wearer. Suitable garments can include, for example, jackets, shirts, pants, coveralls, gloves, head coverings, leg coverings, aprons, footwear or a combination thereof. The garments can be the outermost layer worn by a wearer or can be underwear, intended to be covered by another garment. Typically, however, the garment is the outermost garment. The present disclosure also relates to the use of the laminate structure in manufacturing of a garment, wherein the laminate structure has a total weight that is less than or equal to 500 gsm. In other embodiments, the disclosure also relates to the use of the laminate structure in manufacturing of a garment, wherein the laminate structure has a total weight that is less than or equal to 500 gsm and wherein the laminate structure satisfies an EN 61482-1-2:2014 standard. The disclosure also relates to the use of the laminate structure as a garment.

Stretch may be incorporated into the laminate structure which can increase the comfort of a garment comprising the laminate structure. In some embodiments, one-way stretch can be incorporated, for example, following the disclosure of WO 2018/067529, the disclosure of which is herein incorporated by reference in its entirety. As used herein, one way stretch means that the laminate structure has recoverable elasticity in one of the machine or transverse direction, but typically, not both. Other methods for incorporating stretch into laminate structures, especially those that contain one or more layers that are not inherently elastic are known in the art. Suitable examples can include for example, the teachings of EP 110626 and EP 1852253, the disclosures of which are herein incorporated by reference, in their entireties.

### EXAMPLES

Test Methods

TMA Expansion test: TMA (Thermo-mechanical analysis) was used to measure the expansion of expandable graphite particles. Expansion was tested with TA Instruments TMA 2940 instrument. A ceramic (alumina) TGA pan, measuring roughly 8 mm in diameter and 12 mm in height was used for holding the sample. Using the macroexpansion probe, with a diameter of roughly 6 mm, the bottom of the pan was set to zero. Flakes of expandable graphite about 0.1-0.3 mm deep, as measured by the TMA probe, were put in the pan. The furnace was closed and initial sample height was measured. The furnace was heated from about 25° C. to 600° C. at a ramp rate of 10° C./min. The TMA probe displacement was plotted against temperature; the displacement was used as a measure of expansion.

DSC Endotherm Test: Tests were run on a Q2000 DSC from TA Instruments using TZERO T™ hermetic pans. For each sample, about 3 milligrams (mg) of expandable graphite were placed in the pan. The pan was vented by pressing the corner of a razor blade into the center, creating a vent that was approximately 2 mm long and less than 1 mm wide. The DSC was equilibrated at 20° C. Samples were then heated from 20° C. to 400° C. at 10° C./min. Endotherm values were obtained from the DSC curves.

Barrier Thermal Stability test: Preferably, a thermally stable barrier layer has an air permeability after thermal exposure of less than 25l/m²/sec. To determine the thermal stability of a thermally stable barrier layer, a 381 mm (15 in.) square fabric specimen was clamped in a metal frame and then suspended in a forced air-circulating oven at 260° C. (500° F.). Following a 5-minute exposure, the specimen was removed from the oven. After allowing the specimen to cool down, the air permeability of the specimen was tested according to ISO 9237 (1995). Specimens with less than 25 l/m²/sec were considered as a thermally stable barrier layer.

Horizontal Flame Test was conducted according to EN ISO 15025, method A1. Samples tested according with a 10 second exposure to a Horizontal Flame test and were said to pass if they exhibited no hole greater than 5 millimeter, had an afterflame of less than or equal to 2 seconds and an afterglow of less than or equal to 2 seconds. Each sample was tested by exposing the outer textile layer to the horizontal flame and then repeating the test with a new sample, exposing the inner textile layer to the horizontal flame. Each test was rated based on the side of the laminate that was exposed, therefore, one side could pass the test while the other side could fail.

Self-Extinguishing Test: EN ISO 15025. After the material sample was removed from the flame in the Horizontal Flame Test, above, the material was observed for any after flame and afterflame time was recorded. If the sample exhibits any melt dripping or falling droplets, it was also recorded. If no after flame was observed, or if an after flame is observed upon removal but extinguishes within five (5) seconds after removal from the flame, the material was said to be self-extinguishing.

Vertical Flame Test: was conducted in accordance with EN ISO 15025, method A2. The after-flame time was averaged for 3 samples. Textiles with after-flame and afterglow of greater than 2 seconds were considered as flammable.

Melting and Thermal Stability Test: The test was used to determine the thermal stability of textile materials. This test was based on thermal stability test as described in section 8.3 of NFPA 1975, 2004 Edition. The test oven was a hot air circulating oven as specified in ISO 17493. The test was conducted according to ASTM D 751, Standard Test Methods for Coated Fabrics, using the Procedures for Blocking Resistance at Elevated Temperatures (Sections 89 to 93), with the following modifications:
Borosilicate glass plates measuring 100 mm x100 mm x3 mm (4 in.×4 in.×⅛ in.) were used,
A test temperature of 180° C., ±5° C. was used. The specimens were allowed to cool a minimum of 1 hour after removal of the glass plates from the oven.

Any sample side sticking to glass plate, sticking to itself when unfolded, or showing evidence of melting or dripping was considered as meltable. Any sample side lacking evidence of meltable side was considered as thermally stable.

Moisture Vapor Transmission Rate (MVTR): A description of the test employed to measure MVTR is given below. The procedure has been found to be suitable for testing films, coatings, and coated products.

In the procedure, approximately 70 ml of a solution consisting of 35 parts by weight of potassium acetate and 15 parts by weight of distilled water was placed into a 133 ml polypropylene cup, having an inside diameter of 6.5 cm at its mouth. An expanded PTFE membrane having a minimum MVTR of approximately 85,000 g/m²/24 hrs. as tested by the method described in U.S. Pat. No. 4,862,730 (to Crosby), was heat sealed to the lip of the cup to create a taut, leakproof, microporous barrier containing the solution. A similar expanded PTFE membrane was mounted to the surface of a water bath. The water bath assembly was controlled at 23° C., utilizing a temperature controlled room and a water circulating bath. The sample to be tested was allowed to condition at a temperature of 23° C. and a relative humidity of 50% prior to performing the test procedure. Samples were placed so the microporous polymeric membrane was in contact with the expanded PTFE membrane mounted to the surface of the water bath and allowed to equilibrate for at least 15 minutes prior to the introduction of the cup assembly. The cup assembly was weighed to the nearest 1/1000g and was placed in an inverted manner onto the center of the test sample. Water transport was provided by the driving force between the water in the water bath and the saturated salt solution providing water flux by diffusion in that direction. The sample was tested for 15 minutes and the cup assembly was then removed, weighed again within 1/1000g.

The MVTR of the sample was calculated from the weight gain of the cup assembly and was expressed in grams of water per square meter of sample surface area per 24 hours.

Weight: Weight measurements on materials were conducted as specified in ASTM D751, section 10.

Air Permeability Test: Preferably, a middle layer has an air permeability after thermal exposure of less than 25 l/m²/sec. To determine the thermal stability of a middle layer, a 381 mm (15 in.) square specimen was clamped in a metal frame and then suspended in a forced air-circulating oven set to a temperature of 260° C. Following a 5-minute exposure, the specimen was removed from the oven. After allowing the specimen to cool down, the air permeability of the specimen was tested according to test methods entitled ISO 9237 (1995).

Flexibility or Hand Measurement: Hand measurements of laminate structure samples were obtained using a Thwing-Albert Handle-o-meter (model #211-5 from Thwing Albert Instrument Company, Philadelphia, Pa.). Lower values indicate lower load required to bend the samples and indicates more flexible sample.

Washing of Laminates Washing of each sample was performed using the procedures given in ISO 6330 6N F60. Each wash/dry cycle was performed 5 times. The weight of each sample was determined prior to ISO 6330 6N F60 and after 5 full wash/dry cycles. The value given is the average of three separate samples.

Electric Arc Box Tests were performed using EN 61482-1-2:2014.

Open arc test was performed according to IEC 61482-1-1:2009, method A.

Furnace Expansion Test A nickel crucible was heated in a hot furnace at 300 degrees centigrade for 2 minutes. A measured sample (about 0.5 g) of expandable graphite was added to the crucible and placed in the hot furnace at 300 degrees centigrade for 3 minutes. After the heating period, the crucible was removed from the furnace and allowed to cool and then the expanded graphite was transferred to a measuring cylinder to measure expanded volume. The expanded volume was divided by the initial weight of the sample to get expansion in cc/g units.

Evaporative Resistance Test (RET). A means to evaluate the resistance of a layer or a laminate structure to the transmission of moisture vapor, thus assessing the moisture vapor permeability. Ret is conducted per ISO 11092, 1993 edition, and is expressed in m2 Pa/W. Higher Ret values indicate lower moisture vapor permeability.

Porosity. The measurement of the pore size may take place by means of a Coulter Porometer™ produced by Coulter Electronics, Inc., Hialeah, Fla. The Coulter Porometer is an instrument which determines an automatic measurement of the pore size distribution in porous media according to the method described in ASTM Standard E1298-89.

The pore size nevertheless cannot be determined for all available porous materials by means of the Coulter Porometer. In such a case, the pore size may also be determined, using a microscope, such as, for example, a light-optical or electron microscope.

Thickness Measurement. Thickness was measured by placing the membrane or textile laminate between the two plates of a Mitutoyo 543-252BS Snap Gauge. The average of the three measurements was used.

Unless otherwise noted, the following materials were used.

Outer Textile Layers

Outer Textile layer #1 was a 105 grams/meter² (gsm) twill woven textile including 98% polyethlene terephthalate and 2% antistatic, available from Toray International UK, LTD as part #FFM5318. Outer textile layer #1 was a meltable textile layer according to the Melting and Thermal Stability test.

Outer Textile layer #2 was a 50 gsm interlock knit polyamide textile, available from Borgini srl as part #6039647. Outer textile layer #2 was a meltable textile layer according to the Melting and Thermal Stability test.

Outer Textile layer #3 was a 76 gsm plain woven textile including 98% polyethylene terephthalate and 2% antistatic, available from Toray International UK LTD as part #FFM2362. Outer textile layer #3 was a meltable textile layer according to the Melting and Thermal Stability test.

Outer Textile layer #4 was a 172 gsm woven, 100% polyethylene terephthalate, available from Toray International UK LTD as part #FFM2331. Outer textile layer #4 was a meltable textile layer according to the Melting and Thermal Stability test.

Outer Textile layer #5 was a 77 gsm woven 99% nylon 6,6 containing 1% carbon, available from Toray International UK LTD as part #MGNY000DF. Outer textile layer #5 was a meltable textile layer according to the Melting and Thermal Stability test.

Outer Textile layer #6 was a 75 gsm knit polyamide, available from Borgini srl. Outer textile layer #6 was a meltable textile layer according to the Melting and Thermal Stability test.

Middle Layer

Middle layer #1 was an expanded polytetrafluoroethylene (“ePTFE”) layer commercially available from W.L. Gore and Associates, Elkton, Md. as part number 4410078 and having a basis weight of 22 gsm, a porosity of 50%, a thickness of 100 micrometers and a moisture vapor transmission rate (MVTR) of 20,000 grams/meter²/day.

Middle layer #2 was an ePTFE layer produced according to U.S. Pat. No. 3,953,566 and having a basis weight of 22 gsm, a porosity of 60%, a thickness of 90 micrometers and a moisture vapor transmission rate (MVTR) of 30,000 grams/meter²/day.

Middle layer #3 was an ePTFE layer produced according to U.S. Pat. No. 3,953,566 having a weight of 16.5 gsm.

Inner Layers

Inner layer #1 was a 120 gsm plain woven textile made of 50% aramid and 50% FR viscose, available from Schüler &Co. KG as part #KRVC001.

Inner layer #2 was a 90 gsm jersey knit textile made of 100% modacryl, available from Ames Europe B.V. as part #313602.

Inner layer #3 was a 200 gsm knit textile made of 60% modacryl and 38% cotton/2% antistatic fiber blend, available from TTI Technische Textilien Intemation GmbH as part #1801.

Heat Reactive Material

Heat Reactive Material #1 was produced according to the following procedure. A flame retardant polyurethane resin was prepared by first forming a resin according to commonly owned U.S. Pat. No. 4,532,316 and adding in to the reactor a phosphorus-based flame retardant material, in an amount of about 45% by weight. After the polyurethane resin was formed, 76 grams of the polyurethane resin was mixed with 24 grams of expandable graphite (the expandable graphite having an expansion of greater than 900 micrometers at 280° C. as determined by the TMA expansion test) at 80° C. in a stirring vessel. The mixture was cooled and used as is.

Heat Reactive Material #2 was produced according to the following procedure. A flame retardant polyurethane resin was prepared by first forming a resin according to commonly owned U.S. Pat. No. 4,532,316 and adding in to the reactor a phosphorus-based flame retardant material, in an amount of about 20% by weight. After the polyurethane resin was formed, 65 grams of the polyurethane resin was mixed with 24 grams of expandable graphite (the expandable graphite having an expansion of greater than 900 micrometers at 280° C. as determined by the TMA expansion test) and an additional 17 grams of another phosphorus-based flame retardant material at 80° C. in a stirring vessel. The mixture was cooled and used as is.

Heat Reactive Material #3 was produced in the following manner. A 2-component (A/B) silicone mixture available from Wacker Chemie as ELASTOSIL® LR6200A/B was mixed in a 1:1 mixture according to the manufacturers directions. After mixing to form a homogeneous mixture, about 12% by weight of expandable graphite (the expandable graphite having an expansion of greater than 900 micrometers at 280° C. as determined by the TMA expansion test) and about 12% by weight of a phosphorous-based flame retardant additive was added to the mixture and stirred to form a homogeneous mixture. After mixing, heat reactive material #3 was used as is.

Flame Retardant Adhesive Layer

Flame Retardant Adhesive #1 is a flame retardant polyurethane resin prepared by first forming a resin according to commonly owned U.S. Pat. No. 4,532,316 and adding in to the reactor a phosphorus-based flame retardant material, in an amount of about 20% by weight.

Gravure

Gravure #1 was a pattern of repeating dots providing an adhesive coverage area of about 57% to a substrate and an adhesive laydown of 45-55 gsm. The dot size was about 2 millimeters (mm) by 2 mm and the spacing between adjacent edges of each dot was about 0.6 mm.

Gravure #2 was a grid-like pattern having a first series of parallel lines and a second series of parallel lines that were oriented 90 degrees relative to the first series of parallel lines. Each line was formed from individual dots, the dots having a dot size of 0.5 mm, the dots having a center-to-center distance of 0.713 mm, the lines being 3.4 mm wide and two adjacent parallel lines having a center-to-center distance of 23.53 mm. The areas free from adhesive, i.e., bounded by the adhesive lines was about 404 square millimeters, the area being based on the screen size. The dot pattern provides an adhesive coverage area of about 11% to a substrate and an adhesive laydown of about 3-7 gsm.

Gravure #3 was a pattern of repeating dots providing an adhesive coverage area of about 30% and adhesive laydown of about 6.5 to 7.5 gsm. The dot size is 0.4 mm and the spacing between adjacent edges of each dot was about 0.3 mm.

Gravure #4 is a pattern of dots providing an adhesive coverage area of about 35% and an adhesive laydown of approximately 100-110 gsm. The dots have a size of about 1.6 mm and the spacing between adjacent edges of each dot was about 0.14 mm.

Gravure #5 is a pattern of repeating dots providing an adhesive coverage area of about 40-41% and an adhesive laydown of 6.5 to 10 gsm. The dots have a size of about 500 micrometers and the spacing between adjacent edges of each dot are about 230 micrometers.

### Preparation of Laminate Examples

Each of the laminate examples 1-9 was prepared according to the following procedure.

### Laminate Example 1

Outer textile layer #1 was laminated to middle layer #1 using heat reactive material #1. The heat reactive material was gravure printed using the gravure roll #1 (dot pattern) on the middle layer to provide a laydown of the heat reactive material in the range of 60-70 grams/meter² (gsm). The outer textile layer was placed on top of the layer of heat reactive material and rolled through the nip of two rollers. This laminate was placed on a roll to cure for about 2 days to form a precursor laminate. A layer of flame retardant adhesive material #1 was then applied to the middle layer of the precursor laminate on the side opposite the outer textile layer using the gravure roll #2 (grid-like pattern). Inner layer #1 was then placed on top of the flame retardant adhesive material and rolled through the nip of two rollers. The laminate was then placed on a roll to cure. Finally, a coating of a fluorocarbon-based durable water repellant material was applied to the outer textile layer and the aqueous solvent was removed by heating.

The laminate had an initial weight of 320.2 gsm, a weight after washing of 328.6 gsm, had an initial MVTR of 9300 g/m²/day, and an MVTR after washing of 8637 g/m²/day. The laminate had an initial RET of 8.6 m² Pa/W and an RET after washing of 8.3 m² Pa/W.

### Laminate Example 2

Outer textile layer #1 was laminated to middle layer #1 using heat reactive material #2. The heat reactive material was gravure printed using the gravure roll #1 (dot pattern) on the middle layer to provide a laydown of the heat reactive material in the range of 60-70 gsm. The outer textile layer was placed on top of the layer of heat reactive material and rolled through the nip of two rollers. This laminate was placed on a roll to cure for about 2 days to form a precursor laminate. A layer of flame retardant adhesive material #1 was then applied to the middle layer of the precursor laminate on the side opposite the outer textile layer using the gravure roll #2 (grid-like pattern). Inner layer #1 was then placed on top of the flame retardant adhesive material and rolled through the nip of two rollers. The laminate was then placed on a roll to cure. Finally, a coating of a fluorocarbon-based durable water repellant material was applied to the outer textile layer and the aqueous solvent was removed by heating.

The laminate had an initial weight of 322.2 gsm, a weight after washing of 330.1 gsm, had an initial MVTR of 7325 g/m²/day, and an MVTR after washing of 6836 g/m²/day. The laminate had an initial RET of 11.8 m² Pa/W and an RET after washing of 11.6 m² Pa/W.

### Laminate Example 3

Outer textile layer #1 was laminated to middle layer #2 using heat reactive material #1. The heat reactive material was gravure printed using the gravure roll #1 (dot pattern) on the middle layer to provide a laydown of the heat reactive material in the range of 60-70 gsm. The outer textile layer was placed on top of the layer of heat reactive material and rolled through the nip of two rollers. This laminate was placed on a roll to cure for about 2 days to form a precursor laminate. A layer of flame retardant adhesive material #1 was then applied to the middle layer of the precursor laminate on the side opposite the outer textile layer using the gravure roll #2 (grid-like pattern). Inner layer #1 was then placed on top of the flame retardant adhesive material and rolled through the nip of two rollers. The laminate was then placed on a roll to cure. Finally, a coating of a fluorocarbon-based durable water repellant material was applied to the outer textile layer and the aqueous solvent was removed by heating.

The laminate had an initial weight of 305.3 gsm, a weight after washing of 314.8 gsm, had an initial MVTR of 9537 g/m²/day, and an MVTR after washing of 8843 g/m²/day. The laminate had an initial RET of 8.1 m² Pa/W and an RET after washing of 8.5 m² Pa/W.

### Laminate Example 4

Outer textile layer #2 was laminated to middle layer #1 using heat reactive material #2. The heat reactive material was gravure printed using the gravure roll #1 (dot pattern) on the middle layer to provide a laydown of the heat reactive material in the range of 60-70 gsm. The outer textile layer was placed on top of the layer of heat reactive material and rolled through the nip of two rollers. This laminate was placed on a roll to cure for about 2 days to form a precursor laminate. A layer of flame retardant adhesive material #1 was then applied to the middle layer of the precursor laminate on the side opposite the outer textile layer using the gravure roll #2 (grid-like pattern). Inner layer #1 was then placed on top of the flame retardant adhesive material and rolled through the nip of two rollers. The laminate was then placed on a roll to cure. Finally, a coating of a fluorocarbon-based durable water repellant material was applied to the outer textile layer and the aqueous solvent was removed by heating.

The laminate had an initial weight of 263.5 gsm, a weight after washing of 327.1 gsm, had an initial MVTR of 11697 g/m²/day, and an MVTR after washing of 7314 g/m²/day. The laminate had an initial RET of 6.2 m² Pa/W and an RET after washing of 10.3 m² Pa/W.

### Laminate Example 5

Outer textile layer #4 was laminated to middle layer #2 using heat reactive material #1. The heat reactive material was gravure printed using the gravure roll #1 (dot pattern) on the middle layer to provide a laydown of the heat reactive material in the range of 60-70 gsm. The outer textile layer was placed on top of the layer of heat reactive material and rolled through the nip of two rollers. This laminate was placed on a roll to cure for about 2 days to form a precursor laminate. A layer of flame retardant adhesive material #1 was then applied to the middle layer of the precursor laminate on the side opposite the outer textile layer using the gravure roll #2 (grid-like pattern). Inner layer #1 was then placed on top of the flame retardant adhesive material and rolled through the nip of two rollers. The laminate was then placed on a roll to cure. Finally, a coating of a fluorocarbon-based durable water repellant material was applied to the outer textile layer and the aqueous solvent was removed by heating.

The laminate had an initial weight of 380.7 gsm, a weight after washing of 393.0 gsm, had an initial MVTR of 8719 g/m²/day, and an MVTR after washing of 7870 g/m²/day. The laminate had an initial RET of 8.4 m² Pa/W and an RET after washing of 9.0 m² Pa/W.

### Laminate Example 6

Outer textile layer #3 was laminated to middle layer #1 using heat reactive material #1. The heat reactive material was gravure printed using the gravure roll #1 (dot pattern) on the middle layer to provide a laydown of the heat reactive material in the range of 60-70 gsm. The outer textile layer was placed on top of the layer of heat reactive material and rolled through the nip of two rollers. This laminate was placed on a roll to cure for about 2 days to form a precursor laminate. A layer of flame retardant adhesive material #1 was then applied to the middle layer of the precursor laminate on the side opposite the outer textile layer using the gravure roll #2 (grid-like pattern). Inner layer #1 was then placed on top of the flame retardant adhesive material and rolled through the nip of two rollers. The laminate was then placed on a roll to cure. Finally, a coating of a fluorocarbon-based durable water repellant material was applied to the outer textile layer and the aqueous solvent was removed by heating.

The laminate had an initial weight of 278.3 gsm, a weight after washing of 285.3 gsm, had an initial RET of 6.9 m² Pa/W and an RET after washing of 7.0 m² Pa/W.

### Laminate Example 7

Outer textile layer #3 was laminated to middle layer #3 using heat reactive material #1. The heat reactive material was gravure printed using the gravure roll #1 (dot pattern) on the middle layer to provide a laydown of the heat reactive material in the range of 60-70 gsm. The outer textile layer was placed on top of the layer of heat reactive material and rolled through the nip of two rollers. This laminate was placed on a roll to cure for about 2 days to form a precursor laminate. A layer of flame retardant adhesive material #1 was then applied to the middle layer of the precursor laminate on the side opposite the outer textile layer using the gravure roll #2 (grid-like pattern). Inner layer #1 was then placed on top of the flame retardant adhesive material and rolled through the nip of two rollers. The laminate was then placed on a roll to cure. Finally, a coating of a fluorocarbon-based durable water repellant material was applied to the outer textile layer and the aqueous solvent was removed by heating.

The laminate had an initial weight of 272.0 gsm, a weight after washing of 279.3 gsm, had an initial RET of 7.6 m² Pa/W and an RET after washing of 8.0 m² Pa/W.

### Laminate Example 8

Outer textile layer #6 was laminated to middle layer #1 using heat reactive material #2. The heat reactive material was gravure printed using the gravure roll #1 (dot pattern) on the middle layer to provide a laydown of the heat reactive material in the range of 60-70 gsm. The outer textile layer was placed on top of the layer of heat reactive material and rolled through the nip of two rollers. This laminate was placed on a roll to cure for about 2 days to form a precursor laminate. A layer of flame retardant adhesive material #1 was then applied to the middle layer of the precursor laminate on the side opposite the outer textile layer using the gravure roll #2 (grid-like pattern). Inner layer #1 was then placed on top of the flame retardant adhesive material and rolled through the nip of two rollers. The laminate was then placed on a roll to cure.

The laminate had a weight after washing of 332.0 gsm, an MVTR after washing of 6480 g/m2/day, an RET after washing of 12.1.

### Preparation of Laminate Comparative Examples A through E

### Comparative Laminate A

Outer textile layer #3 was laminated to inner layer #3 using heat reactive material #3. The heat reactive material was gravure printed using gravure roll #4 on the inner layer to provide an adhesive laydown in the range of 60-70 gsm. The outer textile layer was placed on top of the layer of heat reactive material and rolled through the nip of two rollers. This laminate was placed on a roll to cure for about 2 days to form the comparative laminate. Finally, a coating of a durable water repellant material was spray applied to the outer textile layer as an aqueous dispersion and the solvent of the aqueous dispersion was removed by heating the sample.

The laminate had a weight after washing of 349.0 gsm, and an MVTR after washing of 12088 g/m²/day.

### Comparative Laminate B

Outer textile layer #2 was laminated to inner layer #1 using heat reactive material #3. The heat reactive material was gravure printed using gravure roll #4 on the inner layer to provide an adhesive laydown in the range of 60-70 gsm. The outer textile layer was placed on top of the layer of heat reactive material and rolled through the nip of two rollers. This laminate was placed on a roll to cure for about 2 days to form the comparative laminate. Finally, a coating of a durable water repellant material was spray applied to the outer textile layer as an aqueous dispersion and the solvent of the aqueous dispersion was removed by heating the sample.

The laminate had a weight after washing of 269.0 grams/meter², and an MVTR after washing of 13502 g/m²/day.

### Comparative Laminate C

Outer textile layer #3 was laminated to inner layer #1 using heat reactive material #3. The heat reactive material was gravure printed using gravure roll #4 on the inner layer to provide an adhesive laydown in the range of 60-70 gsm. The outer textile layer was placed on top of the layer of heat reactive material and rolled through the nip of two rollers. This laminate was placed on a roll to cure for about 2 days to form the comparative laminate. Finally, a coating of a durable water repellant material was spray applied to the outer textile layer as an aqueous dispersion and the solvent of the aqueous dispersion was removed by heating the sample.

The laminate had a weight after washing of 267.1 grams/meter², and an MVTR after washing of 13065 g/m²/day.

### Comparative Laminate D

Outer textile layer #5 was laminated to inner layer #3 using heat reactive material #3. The heat reactive material was gravure printed using gravure roll #4 on the inner layer to provide an adhesive laydown in the range of 60-70 gsm. The outer textile layer was placed on top of the layer of heat reactive material and rolled through the nip of two rollers. This laminate was placed on a roll to cure for about 2 days to form the comparative laminate. Finally, a coating of a durable water repellant material was spray applied to the outer textile layer as an aqueous dispersion and the solvent of the aqueous dispersion was removed by heating the sample.

The laminate had a weight after washing of 362.2 grams/meter², and an MVTR after washing of 10489 g/m²/day.

### Comparative Example E

Comparative example E was prepared in the same manner as Example 8, with the exception that inner layer #1 was adhered to the precursor laminate using gravure roll #1, which used a dot pattern across the width of the precursor laminate.

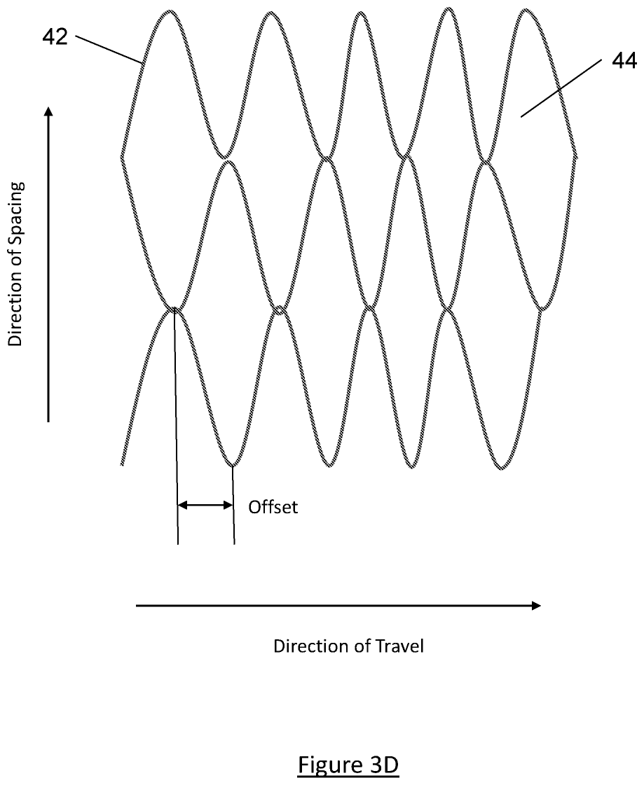

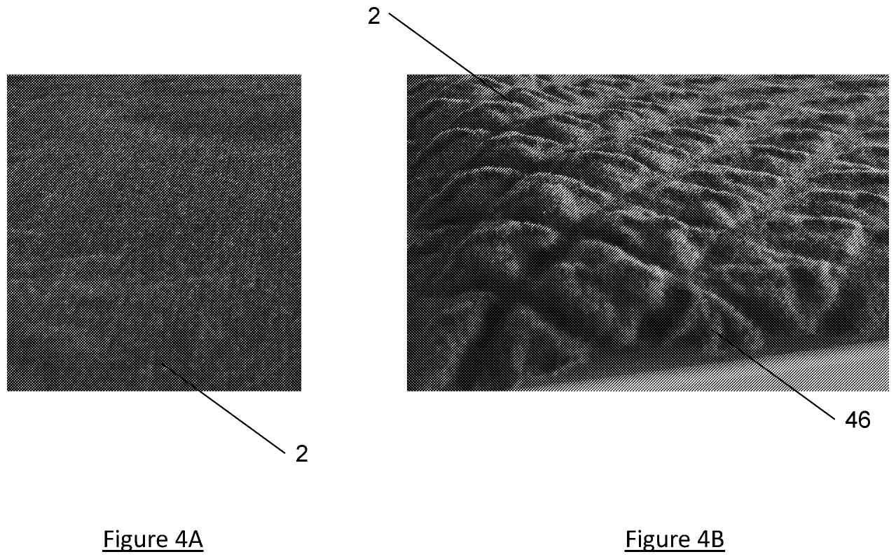

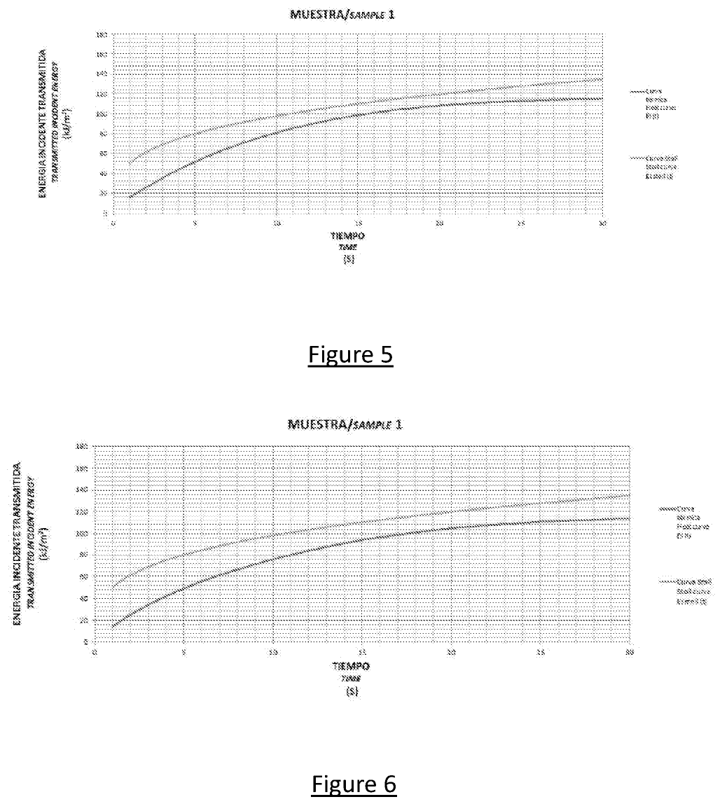

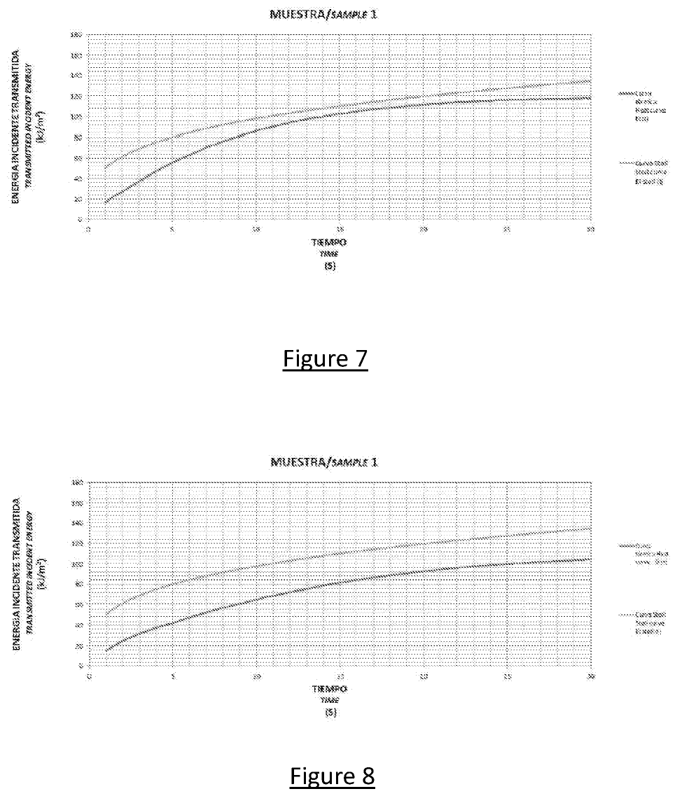

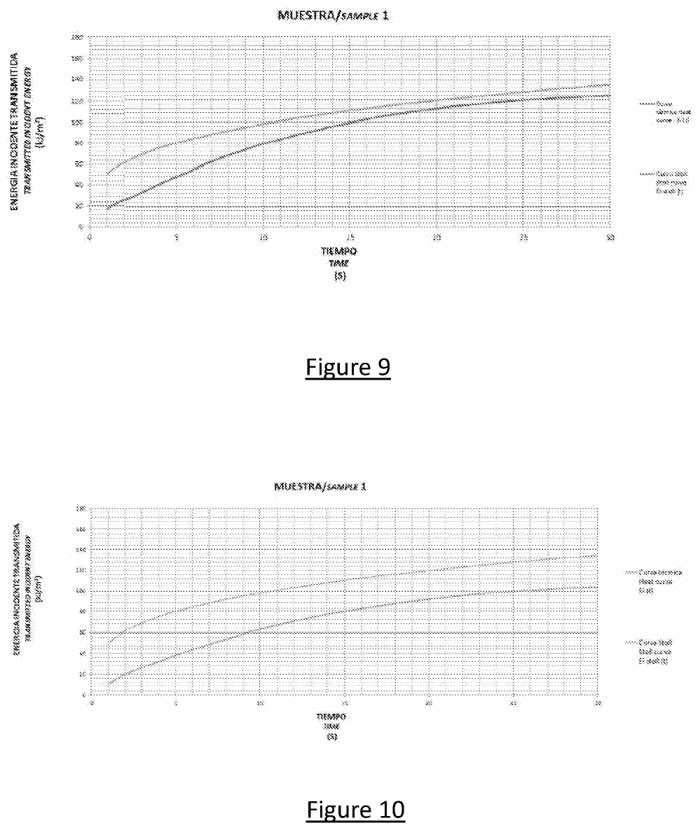

Laminate examples and comparative laminates were subjected to the Arc Flash test according to the test method EN 61482-1-2:2014. In order to prepare the samples for testing, the basis weight for each laminate was determined and then the laminates were subjected to washing as provided in the test procedures herein. After the samples were washed and dried, the basis weight was again determined. Laminate samples were subjected to Test method EN 61482-1-2:2014, after washing, except for laminate example 4 which was tested both before and after washing. In order to analyze each sample, the difference in transmitted energy after 30 seconds was determined, with units of kilojoules/meter². The difference represents the energy transmitted through each sample with respect to the Stoll curve. The Stoll curve is a measure of the transfer of heat energy through a substrate, for example, the laminate, as a function of both the time of exposure and the amount of energy transferred. The Stoll curve is a predictor of second degree burn injury that a person may expect to receive under the applied conditions. Values that fall above the Stoll curve indicate that the wearer may receive a second degree burn. In comparison, values that fall below the Stoll curve is an indication of a low probability of receiving a second degree burn, the further below the Stoll curve, i.e., the more negative the difference, the less likely that a person will be injured by a second degree burn. Samples of each laminate were tested according to the horizontal flame test, provided above. The results of these tests are summarized in Table 1. The results of the trials of Examples 1, 2, 3, 4 and 5 can be seen in FIGS. 5, 6, 7, 8 and 9, respectively, with the exemplary laminates providing levels of protection that are below the Stoll curve.

TABLE 1

| | | | Difference in | | |
|---|---|---|---|---|---|
| | | | transmitted | Horizontal | Horizontal |
| | | Weight (gsm, | energy after 30 | flame (outer | flame (inner |
| Laminate | Weight | after | seconds¹ | textile layer | layer |
| Example | (gsm, initial) | washing) | (kj/m²) | exposure) | exposure) |
| 1 | 320.2 | 328.6 | −14.51 | Pass^{1,2} | Pass^{1,2} |
| 2 | 322.2 | 330.1 | −17.10 | Pass^{1,2} | Pass^{1,2} |
| 3 | 305.3 | 314.8 | −15.37 | Pass^{1,2} | Pass^{1,2} |
| 4 | 263.5 | 327.1 | −18.33²; −30.13 | Pass^{1,2} | Pass^{1,2} |
| 5 | 316.8 | 326.1 | −10.29 | Fail¹, pass² | Pass^{1,2} |
| 6 | 278.3 | 285.3 | −5.28 | Not tested | Not tested |
| 7 | 272.0 | 279.3 | −9.87 | Not tested | Not tested |
| 8 | Not tested | 332 | −26.50 | Pass^{1,2} | Pass^{1,2} |
| A | Not tested | 349.0 | 26.11 | Pass¹ | Pass¹ |
| B | Not tested | 269.0 | 40.21 | Pass¹ | Pass¹ |
| C | Not tested | 267.1 | 30 | Pass¹ | Pass¹ |
| D | Not tested | 362.2 | 36.98 | Pass¹ | Pass¹ |

¹Post-washing
²Pre-washing

The results show that examples 1-8, having the flame retardant adhesive laid down in a pattern and forming a plurality of pockets, can provide excellent protection against exposure to an electrical arc exposure, as evidenced by the difference in transmitted energy when compared to the Stoll curve. Comparative examples A, B, C and D all show values that are above the Stoll curve, indicating a high level of probability of a second degree burn injury.

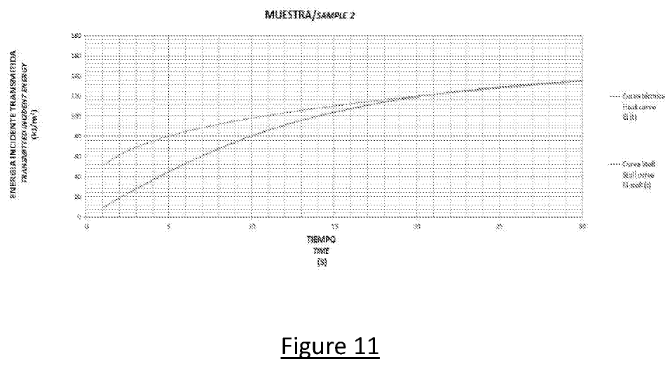

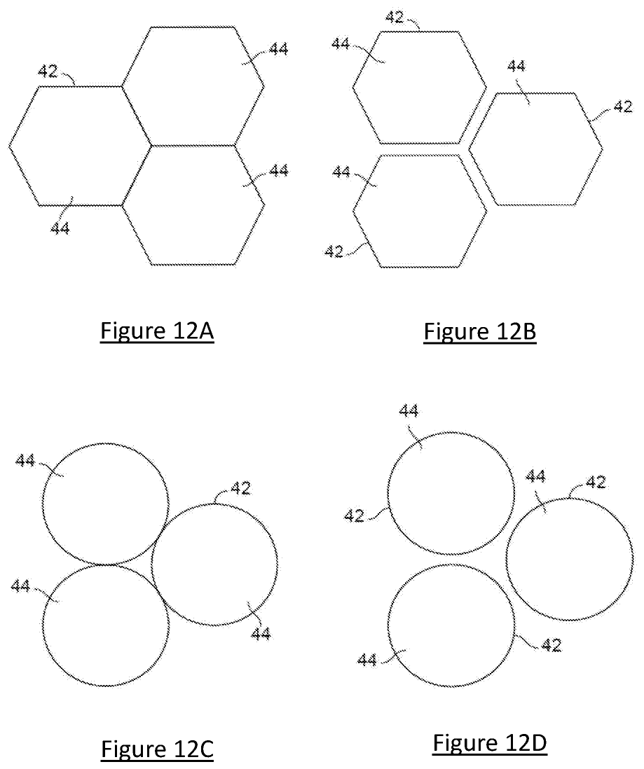

Example 8 and comparative example E were subjected to Test method EN 61482-1-2:2014. Four samples of example 8 were tested while only 2 samples of comparative example E were tested. The results of the test are shown in Table 2. The results of a first trial of Example 8 can be seen in FIG. 10 with the laminate providing levels of protection that are below the Stoll curve. The results of the first trial of Comparative Example E can be seen in FIG. 11 with the values falling above the Stoll curve, indicating a failure to protect a wearer against third-degree burns.

TABLE 2

| Difference of | | Comparative | |
|---|---|---|---|
| transmitted energy | Example 8 | example E | Comparative |
| values compared to | (average | (average | example E |
| the Stoll curve | of 4 trials) | of 2 trials) | (2^{nd} trial) |
| Difference at Tmax, | −28.78 | −7.64 | −3.4 |
| 30 seconds, kj/m² | | | |
| Difference at 10 | −33.13 | −4.2 | −4.1 |
| seconds, kj/m² | | | |
| Difference at 20 | −27.25 | −2 | 0.2 |
| seconds, kj/m² | | | |
| Difference at 30 | −26.50 | −1.5 | 1.05 |
| seconds, kj/m² | | | |

All of the data points of example 8 show that the laminate produces results that are significantly below the Stoll curve.

Garments that produce values that fall below the Stoll curve are listed as negative values, while data points that fall above the Stoll curve are listed as positive values. In the data of Table 2, it can be seen that example 8 produces values that are much lower than comparative example E. The difference between the two samples is the pattern of the FR adhesive between the middle and inner layers. Comparative example E was only replicated twice. The first trial resulted in data points where all of the times were below the Stoll curve. However, in the second trial, several data points were above the Stoll curve, which is an indication that a wearer may have received a second degree burn.

While a number of embodiments of the present invention have been described, it is understood that these embodiments are illustrative only, and not restrictive, and that many modifications may become apparent to those of ordinary skill in the art. Further still, the various steps may be carried out in any desired order (and any desired steps may be added and/or any desired steps may be eliminated).

1. A laminate structure providing thermal insulation, the laminate structure comprising:
an outer textile layer having an outer surface and an inner surface,
a heat reactive material;
a middle layer having an outer surface and an inner surface,
wherein the middle layer is positioned on the heat reactive material opposite the outer textile layer such that the heat reactive material is sandwiched between the inner surface of the outer textile layer and the outer surface of the middle layer, wherein the heat reactive material bonds the middle layer to the outer textile layer;
a flame retardant adhesive material; and
an inner layer having an outer surface and an inner surface,
wherein the inner layer is positioned on the flame retardant adhesive material opposite the middle layer such that the flame retardant adhesive material is sandwiched between the inner surface of the middle layer and the outer surface of the inner layer, wherein the flame retardant adhesive material bonds the inner layer to the middle layer,
wherein the flame retardant adhesive material is positioned in a pattern so as to form a plurality of pockets, each of the pockets defined by (a) the middle layer, (b) the inner layer, and (c) a portion of the flame retardant adhesive material.

2. The laminate structure of claim 1, wherein the outer textile layer has a weight in a range of from 30 grams per square meter (gsm) to 250 gsm.

3. The laminate structure of claim 1, wherein the inner layer has a weight in a range of from 20 gsm to 250 gsm.

4. The laminate structure of claim 1, wherein the outer textile layer comprises a quantity of meltable fibers in a range of from 50 percent by weight to 100 percent by weight, based on the total weight of the outer textile layer.

5. The laminate structure of claim 1, wherein the outer textile layer comprises polyamide fibers, polyester fibers, polyolefin fibers, polyphenylene sulfide fibers, or a combination thereof.

6. The laminate structure of claim 1, wherein the laminate structure shrinks by less than 10% when tested in accordance with a thermal shrinkage test.

7. The laminate structure of claim 1, wherein the inner layer comprises a flame retardant textile, or a textile comprising both flame retardant and meltable fibers.

8. The laminate structure of claim 7, wherein the flame retardant fabric includes p-aramid, m-aramid, polybenzimidazole, polybenzoxazole, polyetheretherketone, polyetherketoneketone, polyphenyl sulfide, polyimide, melamine, fluoropolymer, polytetrafluoroethylene, modacrylic, cellulose, FR viscose, polyvinylacetate, mineral, protein fibers, or a combination thereof.

9. The laminate structure of claim 1, wherein the total weight of the laminate structure is less than or equal to 350 gsm.

10. The laminate structure of claim 1, wherein the middle layer includes expanded polytetrafluoroethylene.

11. The laminate structure of claim 1, wherein the middle layer has a weight in a range of from 10 gsm to 50 gsm.

12. The laminate structure of claim 1, wherein the middle layer is a two-layer film comprising (a) a first layer of expanded polytetrafluoroethylene and (b) a second layer of expanded polytetrafluoroethylene or of polyurethane coated expanded polytetrafluoroethylene.

13. The laminate structure of claim 1, wherein the heat reactive material comprises a mixture of expandable graphite and a polymer resin.

14. The laminate structure of claim 1, wherein the flame-retardant adhesive material covers less than 75% of outer surface of the inner layer.

15. The laminate structure of claim 1, wherein the pattern comprises a grid pattern including a first series of parallel lines oriented in a first direction and a second series of parallel lines oriented in a second direction, the first direction and the section direction being offset from one another at an angle that is in a range of from 30 degrees to 90 degrees.

16. The laminate structure of claim 1, wherein the pattern comprises a series of parallel sinusoidal lines, the sinusoidal lines being offset from one another such that a peak of a first one of the sinusoidal lines is aligned with a trough of an adjacent one of the sinusoidal lines.

17. The laminate structure of claim 1 wherein the middle layer is a thermally stable barrier layer.

18. The laminate structure of claim 1,
wherein the flame retardant adhesive material is positioned in a pattern so as to form a plurality of pockets, each of the pockets defined by (a) the middle layer, (b) the inner layer, and (c) a portion of the flame retardant adhesive material, and wherein the pattern covers less than 75% of the inner layer.

19. A garment comprising the laminate structure of claim 1, wherein the garment is configured such that the inner layer faces a wearer when the garment is worn by the wearer.

20. A method of manufacturing a laminate structure according to claim 1, the method comprising the steps of:
providing an outer textile layer and a middle layer and applying a layer of heat reactive material on the outer textile layer and/or on the middle layer;
sandwiching the heat reactive layer between the inner surface of the outer textile layer and the outer surface of the middle layer, such that the heat reactive material bonds the middle layer to the outer textile layer;
applying flame retardant adhesive material in a pattern to an inner side of the middle layer and/or an outer surface of an inner layer; and
sandwiching the flame retardant adhesive material between the inner surface of the middle layer and the outer surface of the inner layer, such that the flame retardant adhesive material bonds the inner layer to the middle layer and a plurality of pockets are formed, each of the pockets defined by (a) the middle layer, (b) the inner layer, and (c) a portion of the flame retardant adhesive material.

21. The method of claim 20, comprising applying pressure between the middle layer and inner layer, such that the flame retardant adhesive material bonds the inner side of the middle layer and an outer side of the inner layer; and/or applying pressure between the outer textile layer and the middle layer, such that the heat reactive material bonds the inner side of the outer textile layer and the outer side of the middle layer.

22. The method of claim 21, comprising applying pressure to a structure comprising the outer textile layer, the heat reactive material and the middle layer, such that the heat reactive material bonds the inner side of the outer textile layer and the outer side of the middle layer.

23. The method of claim 22, comprising applying pressure to the laminate structure, such that the flame retardant adhesive material bonds the inner side of the middle layer and an outer side of the inner layer.

24. The method of claim 20, comprising applying a durable water repellent coating on the outer textile layer.
